(19) United States
(12) Patent Application Publication
(10) Pub. No.: US 2006/0250529 A1
(43) Pub. Date: Nov. 9, 2006

(54) Display system, display device, display method, recording medium, and program

(75) Inventors: Tetsujiro Kondo, Tokyo (JP); Yoshinori Watanabe, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/401,282

(22) Filed: Apr. 11, 2006

(30) Foreign Application Priority Data
Apr. 28, 2005 (JP) 2005-133358

(51) Int. Cl. H04N 5/44; H04N 5/66

(52) U.S. Cl. 348/739; 348/734

(57) ABSTRACT

A display system includes a first display device and a second display device. The first display device includes a first reception unit receiving a command sent from a remote controller, a first obtaining unit obtaining first information concerning the orientation of the first display device, an addition unit adding the first information to the received command, and a transmission unit transmitting the command to the second display device. The second display device includes a second reception unit receiving the command transmitted from the first display device, a second obtaining unit obtaining second information concerning the orientation of the second display device, a determining unit determining whether the orientation of the second display device is the same as that of the first display device by comparing the first information with the second information, and a processing unit executing predetermined processing in accordance with the command if the two orientations are the same.

### CROSS REFERENCES TO RELATED APPLICATIONS

The present invention contains subject matter related to Japanese Patent Application JP 2005-133358 filed in the Japanese Patent Office on Apr. 28, 2005, the entire contents of which are incorporated herein by reference.

### BACKGROUND OF THE INVENTION

1. Field of the Invention

The present invention generally relates to display systems, display devices, display methods, recording media, and programs. In particular, the invention relates to a display system, a display device, a display method, a recording medium, and a program in which instructions from a remote controller can be reliably received when a plurality of display devices are connected.

2. Description of the Related Art

For example, in a television receiver, a television broadcast signal is received so that images are displayed and sound accompanying the images is output as a television broadcast program. By connecting a plurality of television receivers, some functions that are difficult to achieve by a single television receiver can be implemented.

The following type of display device is disclosed in, for example, Japanese Unexamined Patent Application Publication No. 2003-195843. A display device disclosed in this publication conducts authentication, when detecting that an external display device is connected, with the connected external display device, and changes its functions if authentication has succeeded.

### SUMMARY OF THE INVENTION

When using a plurality of television receivers by being connected to each other, however, it is sometimes difficult to receive instructions given from viewers through a remote controller.

For example, if a plurality of television receivers are connected to each other and are used by turning over all the television receivers or some television receivers, the reception status of commands from the remote controller becomes different depending on the positions of the connected television receivers, and it is thus sometimes difficult to receive instructions given from viewers from the remote controller.

Accordingly, it is desirable to reliably receive instructions from a remote controller.

According to an embodiment of the present invention, there is provided a display system including a first display device and a second display device. The first display device includes first reception means for receiving a command sent from a remote controller in response to a viewer's operation, first obtaining means for obtaining first information concerning the orientation of the first display device in the display system, addition means for adding the obtained first information to the received command, and transmission means for transmitting the command provided with the first information to the second display device. The second display device includes second reception means for receiving the command provided with the first information transmitted from the first display device, second obtaining means for obtaining second information concerning the orientation of the second display device in the display system, determining means for determining whether the orientation of the second display device is the same that of the first display device by comparing the first information added to the command with the obtained second information, and processing means for executing predetermined processing in accordance with the command when it is determined that the orientation of the second display device is the same as the orientation of the first display device.

According to another embodiment of the present invention, there is provided a display system including a first display device and a second display device. The first display device includes a first reception unit configured to receive a command sent from a remote controller in response to a viewer's operation, a first obtaining unit configured to obtain first information concerning the orientation of the first display device in the display system, an addition unit configured to add the obtained first information to the received command, and a transmission unit configured to transmit the command provided with the first information to the second display device. The second display device includes a second reception unit configured to receive the command provided with the first information transmitted from the first display device, a second obtaining unit configured to obtain second information concerning the orientation of the second display device in the display system, a determining unit configured to determine whether the orientation of the second display device is the same as that of the first display device by comparing the first information added to the command with the obtained second information, and a processing unit configured to execute predetermined processing in accordance with the command when it is determined that the orientation of the second display device is the same as the orientation of the first display device.

According to the display system according to an embodiment of the present invention, in the first display device, a command sent from a remote controller in response to a viewer's operation is received, first information concerning the orientation of the first display device in the display system is obtained, the obtained first information is added to the received command, and the command with the first information is transmitted to the second display device. In the second display device, the command provided with the first information sent from the first display device is received, second information concerning the orientation of the second display device in the display system is obtained, it is determined whether the orientation of the second display device is the same as that of the first display device by comparing the first information added to the command with the second information, and if the two orientations are found to be the same, predetermined processing is executed.

According to another embodiment of the present invention, there is provided a first display device including first reception means for receiving a command sent from a remote controller in response to a viewer's operation, first obtaining means for obtaining first information concerning the orientation of the first display device, addition means for adding the obtained first information to the received command, and transmission means for transmitting the command provided with the first information to a different display device.

According to another embodiment of the present invention, there is provided a display device including a first reception unit configured to receive a command sent from a remote controller in response to a viewer's operation, a first obtaining unit configured to obtain first information concerning the orientation of the display device, an addition unit configured to add the obtained first information to the received command, and a transmission unit configured to transmit the command provided with the first information to a different display device.

The display device may further include second obtaining means for obtaining second information concerning a position at which the display device is installed, second reception means for receiving, from the different display device, third information concerning a position at which the different display device is installed and fourth information concerning the orientation of the different display device; determining means for determining, based on the obtained first and second information and the received third and fourth information, whether the display device is installed at a predetermined position among display devices facing in the same orientation, and mode control means for receiving, if it is determined that the display device is installed at the predetermined position, the command sent from the remote controller and shifting a mode of the display device to a first mode in which the received command is transmitted to the different display device, and if it is determined that the display device is not installed at the predetermined position, the mode control means shifting the mode of the display device to a second mode in which a command sent from the different display device is received without receiving the command sent from the remote controller.

The display device may further include storage means for storing second information concerning the number of commands received from the remote controller, second reception means for receiving, from the different display device, third information concerning the number of commands received by the different display device and fourth information concerning the orientation of the different display device, determining means for determining, based on the obtained first information, the stored second information, and the received third and fourth information, whether the reception status of the display device is the best among display devices facing in the same orientation, and mode control means for receiving, if it is determined that the reception status of the display device is the best, the command sent from the remote controller and shifting the mode of the display device to a first mode in which the received command is transmitted to the different display device, and if it is determined that the reception status of the display device is not the best, the mode control means shifting the mode of the display device to a second mode in which a command sent from the different display device is received without receiving the command sent from the remote controller.

According to another embodiment of the present invention, there is provided a first display method including the steps of controlling the reception of a command sent from a remote controller in response to a viewer's operation, obtaining first information concerning the orientation of a subject display device, adding the obtained first information to the received command, and controlling the transmission of the command provided with the first information to a different display device.

According to another embodiment of the present invention, there is provided a first program executed by a computer, including the steps of controlling the reception of a command sent from a remote controller in response to a viewer's operation, obtaining first information concerning the orientation of a subject display device, adding the obtained first information to the received command, and controlling the transmission of the command provided with the first information to a different display device.

According to another embodiment of the present invention, there is provided a first recording medium recording thereon a program executed by a computer. The program includes the steps of controlling the reception of a command sent from a remote controller in response to a viewer's operation, obtaining first information concerning the orientation of a subject display device, adding the obtained first information to the received command, and controlling the transmission of the command provided with the first information to a different display device.

According to the first display device, method, recording medium, and program according to an embodiment of the present invention, a command sent from a remote controller in response to a viewer's operation is received, first information concerning the orientation of the first display device is obtained, the first information is added to the received command, and the command is transmitted to a different display device.

According to another embodiment of the present invention, there is provided a second display device including reception means for receiving, from a different display device, a command sent from a remote controller provided with first information concerning the orientation of the different display device, first obtaining means for obtaining second information concerning the orientation of the second display device, determining means for determining whether the orientation of the second display device is the same as the orientation of the different display device by comparing the first information added to the command with the obtained second information, and processing means for executing predetermined processing in accordance with the command if it is determined that the orientation of the second display device is the same as the orientation of the different display device.

According to another embodiment of the present invention, there is provided a display device including a reception unit configured to receive, from a different display device, a command sent from a remote controller provided with first information concerning the orientation of the different display device, a first obtaining unit configured to obtain second information concerning the orientation of the display device, a determining unit configured to determine whether the orientation of the display device is the same as that of the different display device by comparing the first information added to the command with the obtained second information, and a processing unit configured to execute predetermined processing in accordance with the command if it is determined that the orientation of the display device is the same as the orientation of the different display device.

The reception means may receive, from the different display device, the first information and third information concerning a position at which the different display device is installed.

The display device may further include second obtaining means for obtaining fourth information concerning a position at which the display device is installed, determining means for determining, based on the received first and third information and the obtained second and fourth information, whether the display device is installed at a predetermined position among display devices facing in the same orientation, and mode control means for receiving, if it is determined that the display device is installed at the predetermined position, the command sent from the remote controller and shifting the mode of the display device to a first mode in which the received command is transmitted to the different display device, and if it is determined that the display device is not installed at the predetermined position, the mode control means shifting the mode of the display device to a second mode in which the command sent from the different display device is received without receiving the command sent from the remote controller.

The reception means may receive, from the different display device, the first information and third information concerning the number of commands received by the different display device.

The display device may further include storage means for storing fourth information concerning the number of commands received from the remote controller, determining means for determining, based on the received first and third information, the obtained second information, and the stored fourth information, whether the reception status of the display device is the best among display devices facing in the same orientation, and mode control means for receiving, if it is determined that the reception status of the display device is the best, the command sent from the remote controller and shifting the mode of the display device to a first mode in which the received command is transmitted to the different display device, and if it is determined that the reception status of the display device is not the best, the mode control means shifting the mode of the display device to a second mode in which the command sent from the different display device is received without receiving the command sent from the remote controller.

According to another embodiment of the present invention, there is provided a second display method including the steps of controlling the reception of, from a different display device, a command sent from a remote controller provided with first information concerning the orientation of the different display device, obtaining second information concerning the orientation of a subject display device, determining whether the orientation of the subject display device is the same as that of the different display device by comparing the first information added to the command with the obtained second information, and executing predetermined processing in accordance with the command if it is determined that the orientation of the subject display device is the same as that of the different display device.

According to another embodiment of the present invention, there is provided a second program executed by a computer, including the steps of controlling the reception of, from a different display device, a command sent from a remote controller provided with first information concerning the orientation of the different display device, obtaining second information concerning the orientation of a subject display device, determining whether the orientation of the subject display device is the same as that of the different display device by comparing the first information added to the command with the obtained second information, and executing predetermined processing in accordance with the command if it is determined that the orientation of the subject display device is the same as that of the different display device.

According to another embodiment of the present invention, there is provided a second recording medium recording thereon a program executed by a computer. The program includes the steps of controlling the reception of, from a different display device, a command sent from a remote controller provided with first information concerning the orientation of the different display device, obtaining second information concerning the orientation of a subject display device, determining whether the orientation of the subject display device is the same as that of the different display device by comparing the first information added to the command with the obtained second information, and executing predetermined processing in accordance with the command if it is determined that the orientation of the subject display device is the same as that of the different display device.

According to the second display device, method, recording medium, and program according to an embodiment of the present invention, a command sent from a remote controller provided with first information concerning the orientation of a different display device is received, second information concerning the orientation of the second display device is obtained, it is determined whether the orientation of the second display device is the same as that of the different display device by comparing the first information added to the command with the second information, and if the two orientations are found to be the same, predetermined processing is executed in accordance with the command.

According to an embodiment of the present invention, instructions from a remote controller can be reliably received.

### BRIEF DESCRIPTION OF THE DRAWINGS

FIG. 1 is an external view illustrating a display set;

FIGS. 2A and 2B illustrate grouping of television receivers into those facing the front side and those facing the back side of a display set;

FIG. 3 illustrates the relationship between a main unit and sub-units when all television receivers forming a display set face the front side;

FIG. 4 illustrates the relationship between a main unit and sub-units when some television receivers forming a display set face the back side;

FIG. 5 is a block diagram illustrating an example of the configuration of a main unit;

FIG. 6 is a block diagram illustrating an example of the functional configuration of the main unit;

FIG. 7 is a block diagram illustrating an example of the functional configuration of a sub-unit;

FIG. 8 is a flowchart illustrating an example of command distributor determining processing;

FIG. 9 illustrates an example of positional information and orientation information concerning other television receivers sent from the other television receivers;

FIG. 10 is a flowchart illustrating another example of command distributor determining processing;

FIG. 11 illustrates an example of number-of-command information and orientation information concerning other television receivers sent from the other television receivers;

FIG. 12 is a flowchart illustrating command distribution processing;

FIGS. 13A and 13B illustrate a remote controller command without orientation information and a remote controller command with orientation information, respectively;

FIG. 14 is a flowchart illustrating command reception processing;

FIG. 15 illustrates remote controller commands sent and received among a remote controller, a main unit, and a sub-unit;

FIG. 16 illustrates a display set provided with remote controller sensors; and

FIG. 17 is a block diagram illustrating a computer according to an embodiment of the present invention.

### DESCRIPTION OF THE PREFERRED EMBODIMENTS

Before describing an embodiment of the present invention, the correspondence between the features of the claims and the embodiment of the present invention is discussed below. This description is intended to assure that the embodiment supporting the claimed invention is described in this specification. Thus, even if an element in the following embodiment is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

Furthermore, this description should not be construed as restricting that all the aspects of the invention disclosed in the embodiment are described in the claims. That is, the description does not deny the existence of aspects of the present invention that are described in the embodiment but not claimed in the invention of this application, i.e., the existence of aspects of the present invention that in future may be claimed by a divisional application, or that may be additionally claimed through amendments.

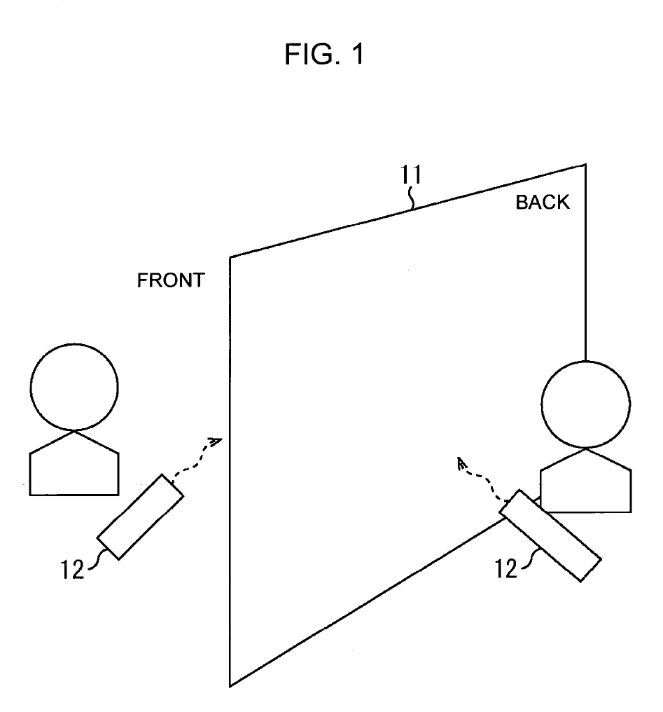

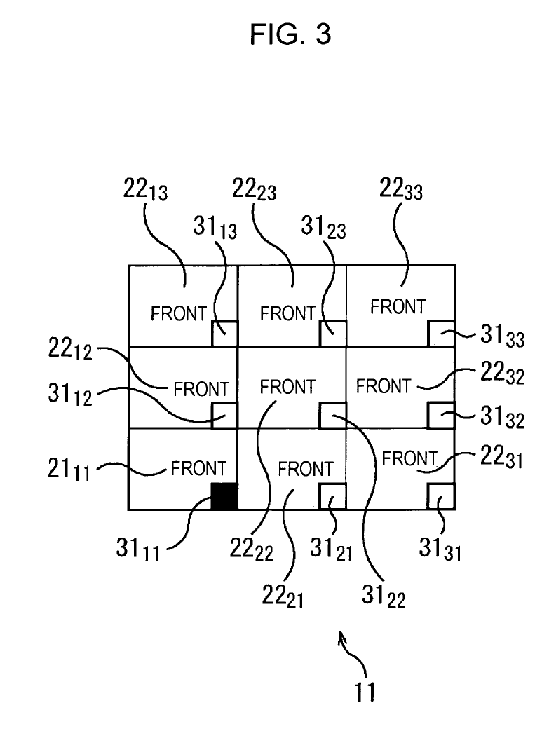

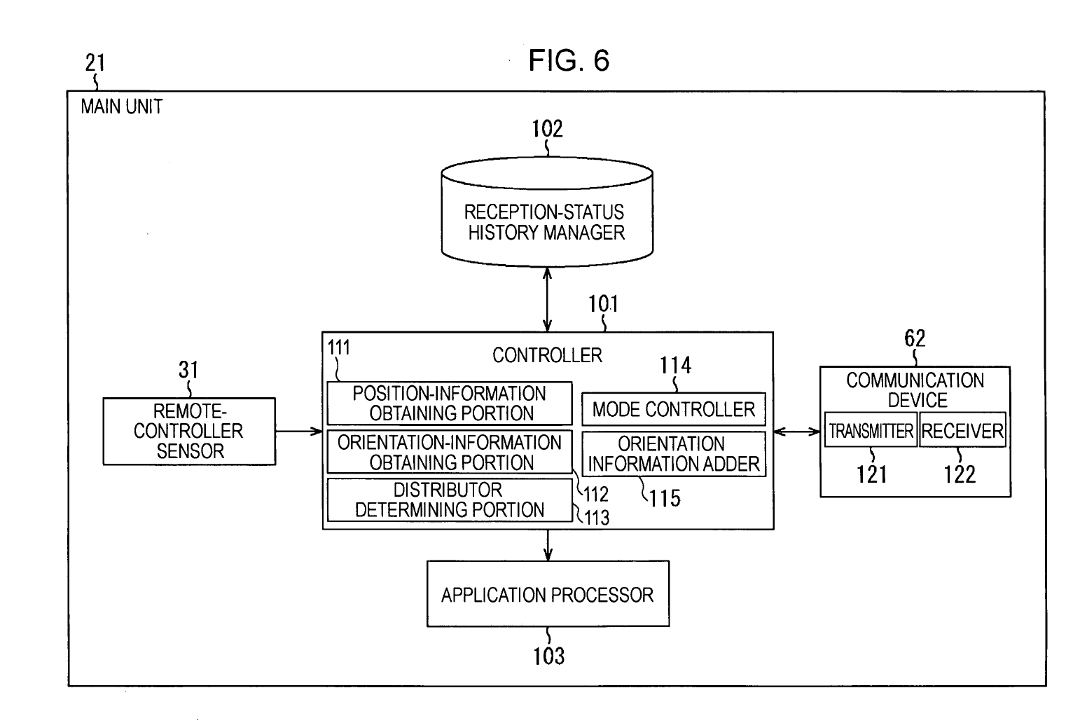

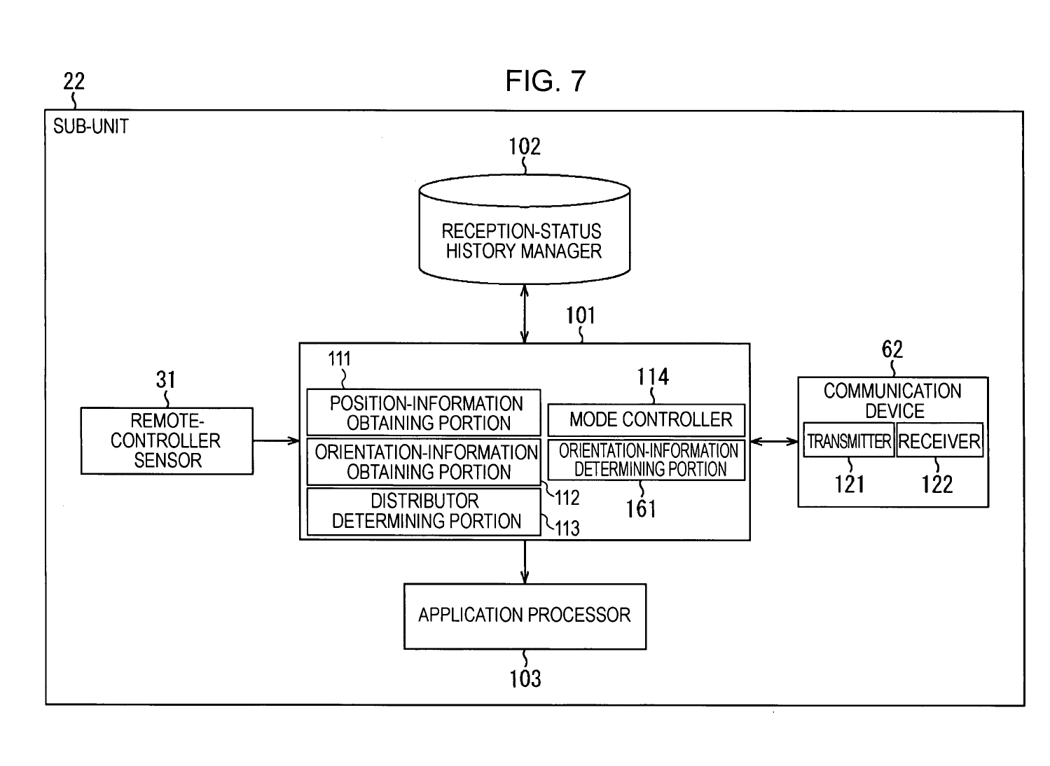

A display system (for example, a display set 11 shown in FIG. 1) according to an embodiment of the present invention includes a first display device (for example, a main unit 21 shown in FIG. 3) and a second display device (for example, a sub-unit 22 shown in FIG. 3). The first display device includes first reception means (for example, a remote controller sensor 31 shown in FIG. 6) for receiving a command (for example, a remote controller command) sent from a remote controller (for example, a remote controller 12 shown in FIG. 1) in response to a viewer's operation, first obtaining means (for example, an orientation-information obtaining portion 112 shown in FIG. 6) for obtaining first information (for example, orientation information) concerning the orientation of the first display device in the display system, addition means (for example, an orientation information adder 115 shown in FIG. 6) for adding the obtained first information to the received command, and transmission means (for example, a transmitter 121 shown in FIG. 6) for transmitting the command provided with the first information to the second display device. The second display device includes second reception means (for example, a communication device 62 shown in FIG. 7) for receiving the command provided with the first information transmitted from the first display device, second obtaining means (for example, an orientation-information obtaining portion 112 shown in FIG. 7) for obtaining second information (for example, orientation information) concerning the orientation of the second display device in the display system, determining means (for example, an orientation-information determining portion 161 shown in FIG. 7) for determining whether the orientation of the second display device is the same as that of the first display device by comparing the first information added to the command with the obtained second information, and processing means (for example, an application processor 103 shown in FIG. 7) for executing predetermined processing in accordance with the command when it is determined that the orientation of the second display device is the same as that of the first display device.

A display device (for example, the main unit 21 shown in FIG. 3) according to an embodiment of the present invention includes first reception means (for example, the remote controller sensor 31 shown in FIG. 6) for receiving a command (for example, a remote controller command) sent from a remote controller (for example, the remote controller 12 shown in FIG. 1) in response to a viewer's operation, first obtaining means (for example, the orientation-information obtaining portion 112 shown in FIG. 6) for obtaining first information (for example, orientation information) concerning the orientation of the display device, addition means (for example, the orientation information adder 115 shown in FIG. 6) for adding the obtained first information to the received command, and transmission means (for example, the transmitter 121 shown in FIG. 6) for transmitting the command provided with the first information to a different display device (for example, the sub-unit 22).

The display device (for example, the main unit 21 shown in FIG. 3) may further include second obtaining means (for example, a position-information obtaining portion 111 shown in FIG. 6) for obtaining second information (for example, position information) concerning a position at which the display device is installed, second reception means (for example, a receiver 122 shown in FIG. 6) for receiving, from the different display device, third information (for example, position information) concerning a position at which the different display device is installed and fourth information (for example, orientation information) concerning the orientation of the different display device, determining means (for example, a distributor determining portion 113 shown in FIG. 6) for determining, based on the obtained first and second information and the received third and fourth information, whether the display device is installed at a predetermined position among display devices facing in the same orientation, and mode control means (for example, a mode controller 114 shown in FIG. 6) for receiving, if it is determined that the display device is installed at the predetermined position, the command sent from the remote controller and shifting a mode of the display device to a first mode (for example, a command distributor mode) in which the received command is transmitted to the different display device, and if it is determined that the display device is not installed at the predetermined position, the mode control means shifting the mode of the display device to a second mode (for example, a command receiver mode) in which a command sent from the different display device is received without receiving the command sent from the remote controller.

The display device (for example, the main unit 21 shown in FIG. 3) may further include storage means (for example, a reception-status history manager 102 shown in FIG. 6) for storing second information (for example, the number of commands) concerning the number of commands received from the remote controller, second reception means (for example, the receiver 122 shown in FIG. 6) for receiving, from the different display device, third information (for example, the number of commands) concerning the number of commands received by the different display device and fourth information (for example, orientation information) concerning the orientation of the different display device, determining means (for example, the distributor determining portion 113 shown in FIG. 6) for determining, based on the obtained first information, the stored second information, and the received third and fourth information, whether the reception status of the display device is the best among display devices facing in the same orientation, and mode control means (for example, the mode controller 114 shown in FIG. 6) for receiving, if it is determined that the reception status of the display device is the best, the command sent from the remote controller and shifting the mode of the display device to a first mode (for example, the command distributor mode) in which the received command is transmitted to the different display device, and if it is determined that the reception status of the display device is not the best, the mode control means shifting the mode of the display device to a second mode (for example, the command receiver mode) in which a command sent from the different display device is received without receiving the command sent from the remote controller.

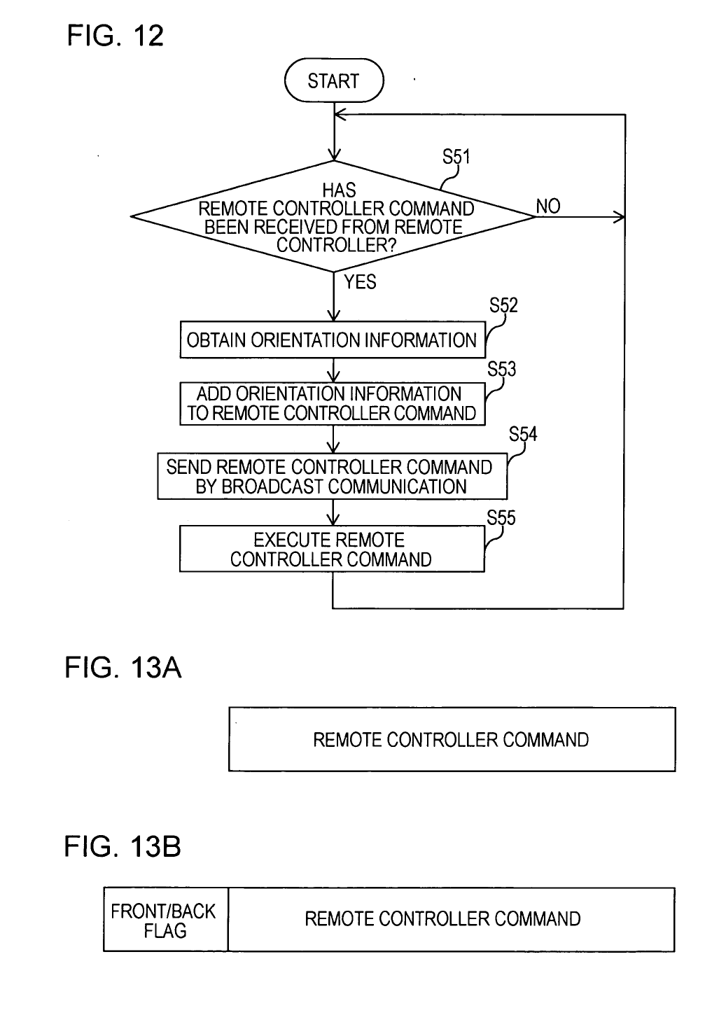

A display method according to an embodiment of the present invention includes the steps of controlling the reception of a command sent from a remote controller in response to a viewer's operation (for example, step S51 in FIG. 12), obtaining first information concerning the orientation of a subject display device (for example, step S52 in FIG. 12), adding the obtained first information to the received command (for example, step S53 in FIG. 12), and controlling the transmission of the command provided with the first information to a different display device (for example, step S54 in FIG. 12).

A program executed by a computer according to an embodiment of the present invention includes the steps of controlling the reception of a command sent from a remote controller in response to a viewer's operation (for example, step S51 in FIG. 12), obtaining first information concerning the orientation of a subject display device (for example, step S52 in FIG. 12), adding the obtained first information to the received command (for example, step S53 in FIG. 12), and controlling the transmission of the command provided with the first information to a different display device (for example, step S54 in FIG. 12).

A display device (for example, the sub-unit 22 shown in FIG. 3) according to an embodiment of the present invention includes reception means (for example, the receiver 122 shown in FIG. 7) for receiving, from a different display device (for example, the main unit 21 shown in FIG. 3), a command (for example, a remote controller command) sent from a remote controller (for example, the remote controller 12 shown in FIG. 1) provided with first information (for example, orientation information) concerning the orientation of the different display device, first obtaining means (for example, the orientation-information obtaining portion 112 shown in FIG. 7) for obtaining second information (for example, orientation information) concerning the orientation of the display device, determining means (for example, the orientation-information determining portion 161 shown in FIG. 7) for determining whether the orientation of the display device is the same as the orientation of the different display device by comparing the first information added to the command with the obtained second information, and processing means (for example, the application processor 103 shown in FIG. 7) for executing predetermined processing in accordance with the command if it is determined that the orientation of the display device is the same as the orientation of the different display device.

The reception means may receive, from the different display device, the first information and third information (for example, position information) concerning a position at which the different display device is installed.

The display device (for example, the sub-unit 22 shown in FIG. 3) may further include second obtaining means (for example, the position-information obtaining portion 111 shown in FIG. 7) for obtaining fourth information (for example, position information) concerning a position at which the display device is installed, determining means (for example, the distributor determining portion 113 shown in FIG. 7) for determining, based on the received first and third information and the obtained second and fourth information, whether the display device is installed at a predetermined position among display devices facing in the same orientation, and mode control means (for example, the mode controller 114 shown in FIG. 7) for receiving, if it is determined that the display device is installed at the predetermined position, the command sent from the remote controller and shifting the mode of the display device to a first mode (for example, the command distributor mode) in which the received command is transmitted to the different display device, and if it is determined that the display device is not installed at the predetermined position, the mode control means shifting the mode of the display device to a second mode (for example, the command receiver mode) in which the command sent from the different display device is received without receiving the command sent from the remote controller.

The reception means may receive, from the different display device, the first information and third information (for example, the number of commands) concerning the number of commands received by the different display device.

The display device (for example, the sub-unit 22 shown in FIG. 3) may further include storage means (for example, the reception-status history manager 102 shown in FIG. 7) for storing fourth information (for example, the number of commands) concerning the number of commands received from the remote controller, determining means (for example, the distributor determining portion 113 shown in FIG. 7) for determining, based on the received first and third information, the obtained second information, and the stored fourth information, whether the reception status of the display device is the best among display devices facing in the same orientation, and mode control means (for example, the mode controller 114 shown in FIG. 7) for receiving, if it is determined that the reception status of the display device is the best, the command sent from the remote controller and shifting the mode of the display device to a first mode (for example, the command distributor mode) in which the received command is transmitted to the different display device, and if it is determined that the reception status of the display device is not the best, the mode control means shifting the mode of the display device to a second mode (for example, the command receiver mode) in which the command sent from the different display device is received without receiving the command sent from the remote controller.

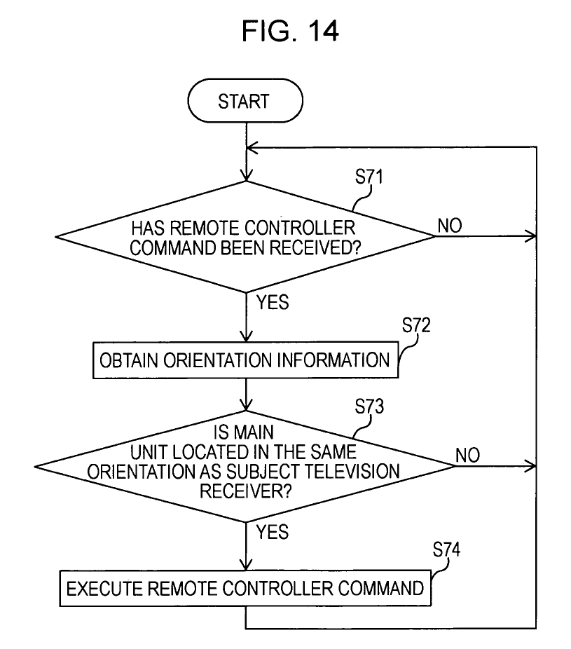

A display method according to an embodiment of the present invention includes the steps of controlling the reception of, from a different display device, a command sent from a remote controller provided with first information concerning the orientation of the different display device (for example, step S71 in FIG. 14), obtaining second information concerning the orientation of a subject display device (for example, step S72 in FIG. 14), determining whether the orientation of the subject display device is the same as that of the different display device by comparing the first information added to the command with the obtained second information (for example, step S73 in FIG. 14), and executing predetermined processing in accordance with the command if it is determined that the orientation of the subject display device is the same as that of the different display device (for example, step S74 in FIG. 14).

A program executed by a computer according to an embodiment of the present invention includes the steps of controlling the reception of, from a different display device, a command sent from a remote controller provided with first information concerning the orientation of the different display device (for example, step S71 in FIG. 14), obtaining second information concerning the orientation of a subject display device (for example, step S72 in FIG. 14), determining whether the orientation of the subject display device is the same as that of the different display device by comparing the first information added to the command with the obtained second information (for example, step S73 in FIG. 14), and executing predetermined processing in accordance with the command if it is determined that the orientation of the subject display device is the same as that of the different display device (for example, step S74 in FIG. 14).

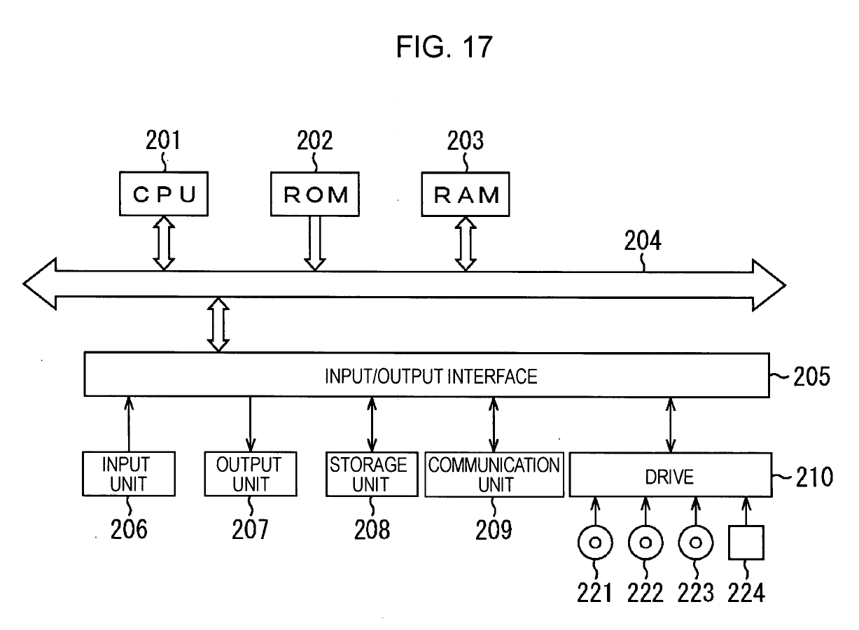

The above-described program may be recorded on a recording medium, for example, a magnetic disk 221 shown in FIG. 17).

An embodiment of the present invention is described in detail below with reference to the accompanying drawings.

FIG. 1 is an external view illustrating a display set 11, which is an example of a display system according to an embodiment of the present invention. The display set 11 includes a plurality of television receivers (main unit 21 or sub-units 22, which are discussed below), each of the television receivers forming an example of a display device according to an embodiment of the present invention.

The television receivers are connected to each other by, for example, a local area network (LAN) conforming with the Ethernet standards, a wireless LAN conforming with the IEEE (The Institute of Electrical and Electronic Engineers, Inc.) 802.11 standards, or serial communication, such as IEEE 1394, USB (Universal Serial Bus), or RS-232C (Recommended Standard 232 version C).

In the display set 11, by connecting a plurality of television receivers, each television receiver displays images of a television broadcast signal received by an antenna (not shown) on a display (display device 58, which is discussed below), and outputs sound accompanying the images from a speaker (speaker 60, which is discussed below).

By connecting, for example, 3(column)×3(row)-television receivers, the display set 11 can display the image enlarged from the images represented by a television reception signal received by the individual television receivers on the entire display of the 3×3 television receivers and outputs sound accompanying the entire image from a speaker.

In the display set 11, each television receiver can be turned over, which enables viewers to watch programs on either side. For example, the viewer can watch a program on the front side at the left of the display set 11 or the back side at the right of the display set 11, as shown in FIG. 1. Details of viewing programs on either side of the display set 11 are discussed later. It is also possible to remove some television receivers from the connected television receivers forming the display set 11.

For example, in the display set 11 including 3×3-television receivers, if the three television receivers at the center (the second column from the left) are turned over to the back, the viewer located at the left side in FIG. 1 can watch programs on the displays of the six television receivers at the left side (the first column from the left) and the right side (the third column from the left) facing the front side, while the viewer located at the right side in FIG. 1 can watch programs on the displays of the three central television receivers facing the back side.

A remote controller 12 sends an operation signal as, for example, infrared or radio waves, in response to a viewer's operation, (hereinafter referred to as a “remote controller command”) to each of the plurality of television receivers combined as the display set 11. For example, the remote controller 12 sends a remote controller command indicating power ON/OFF, channel switching, volume adjustment, or brightness adjustment, to each of the plurality of television receivers.

Each television receiver receives the remote controller command sent from the remote controller 12 and executes processing in accordance with the received remote controller command. If the viewer presses the OFF button of the remote controller 12, each television receiver receives a remote controller command indicating “power OFF” sent from the remote controller 12 and switches OFF the power in accordance with the received command.

When programs are watched on either side, i.e., the front side or the back side, by turning over or removing some television receivers of the display set 11, the viewer facing the front at the left side in FIG. 1 and the viewer facing the back at the right side in FIG. 1 are different. In this case, even if the viewer at the left side wishes to switch OFF the power of the television receivers facing the front side, the viewer at the right side may not wish to switch OFF the power of the television receivers facing the back side. In this manner, in most cases, the operations performed on the remote controller 12 by one viewer do not coincide with those by the other viewer.

Accordingly, for example, when the viewer at the left side operates the remote controller 12, it is necessary that only the television receivers facing the front side execute the processing in accordance with the remote controller command received from the remote controller 12 and that the television receivers facing the back side do not execute processing. On the other hand, when the viewer at the right side operates the remote controller 12, it is necessary that only the television receivers facing the back side execute the processing in accordance with the remote controller command received from the remote controller 12 and that the television receivers facing the front side do not execute processing.

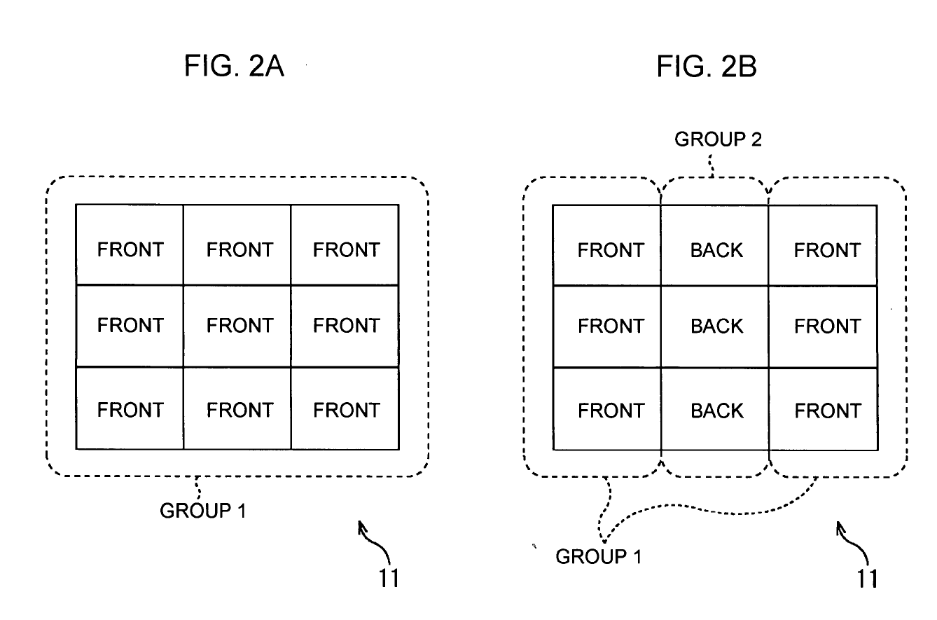

Details of the operation performed by the display set 11 upon receiving a remote controller command sent from the remote controller 12 by the viewer's operation are discussed below with reference to FIGS. 2A through 4.

Grouping of television receivers into those facing the front side and those facing the back side in the television set 11 are described first with reference to FIGS. 2A and 2B.

In examples shown in FIGS. 2A and 2B, the display set 11 includes nine (3×3) television receivers. In the example shown in FIG. 2A, all the television receivers face the front side, and in the example shown in FIG. 2B, among the nine television receivers, the six television receivers at the left side (the first column from the left) and the right side (the third column from the left) face the front side and the remaining three television receivers (the second column from the left) face the back side.

In the example shown in FIG. 2A, since all the television receivers combined as the television set 11 face the front side, they can collectively execute the processing in accordance with a remote controller command sent from the remote controller 12 without the need to separately consider the processing executed by the television receivers facing the front side and the processing executed by the television receivers facing the back side. Accordingly, the nine television receivers facing the front side are classified into group 1.

In the example shown in FIG. 2A, when the viewer operates the remote controller 12 to send a remote controller command to the television receivers facing the front side, all the nine television receivers of group 1 execute the processing in accordance with the remote controller command. Accordingly, the viewer can operate the television receivers facing the front side.

On the other hand, in the example shown in FIG. 2B, among the nine television receivers combined as the display set 11, the six television receivers at the left and right sides face the front side and the remaining three television receivers at the center face the back side. It is thus necessary to separately control the television receivers facing the front side and those facing the back side to execute processing when receiving a remote controller command from the remote controller 12. For example, the six television receivers of the first and third columns from the left are classified into group 1, and the remaining three television receivers are classified into group 2.

In the example shown in FIG. 2B, when the viewer operates the remote controller 12 to send a remote controller command to the television receivers facing the front side, the six television receivers of group 1 execute the processing in response to the remote controller command received from the remote controller 12. Accordingly, the viewer operates the television receivers facing the front side. In contrast, when the viewer operates the remote controller 12 to send a remote controller command to the television receivers facing the back side, the three television receivers of group 2 execute the processing in response to the remote controller command received from the remote controller 12. Accordingly, the viewer operates the television receivers facing the back side.

In this manner, by grouping television receivers into those facing the front side and those facing the back side separately, the viewer operates the remote controller 12 to send a remote controller command indicating, for example, power ON/OFF, channel switching, volume adjustment, or brightness adjustment, to the group facing the front side or the group facing the back side, and controls the television receivers in the group which has received the remote controller command to execute processing in accordance with the remote controller command.

More specifically, if the viewer presses the OFF button of the remote controller 12 to send a remote controller command indicating “power OFF” to the television receivers facing the front side of the display set 11, the television receivers of group 1 facing the front side switch OFF the power, while the television receivers of group 2 facing the back side remain operating without switching OFF the power. In contrast, when the viewer presses the OFF button of the remote controller 12 to send a remote controller command indicating “power OFF” to the television receivers facing the back side of the display set 11, the television receivers of group 2 facing the back side switch OFF the power, while the television receivers of group 1 facing the front side remain operating without switching OFF the power.

There are two types of television receivers which form the display set 11, that is, a main television receiver (hereinafter referred to as a “main unit”) that can transfer a remote controller command received from the remote controller 12 to another television receiver to control it to execute the remote controller command, and sub-television receivers (hereinafter referred to as “sub-units”) that can receive a remote controller command from another television receiver (main unit) and executes the remote controller command.

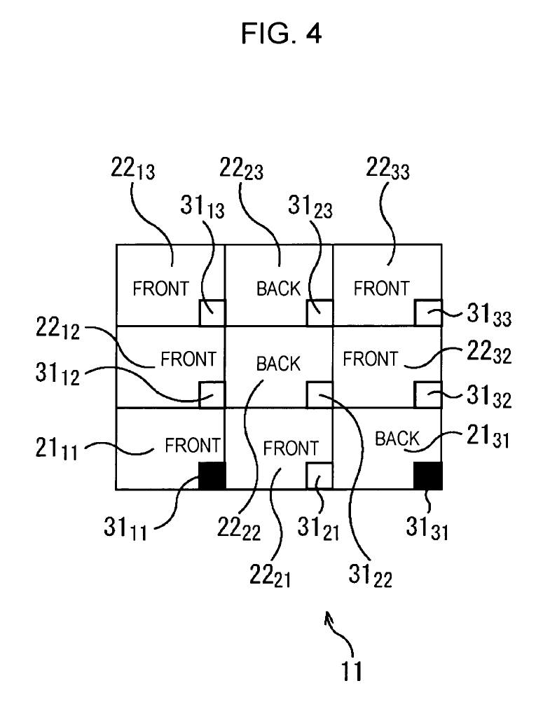

The relationship between the main unit and sub-units in the display set 11 is described below with reference to FIGS. 3 and 4. A description is first given, with reference to FIG. 3, of the relationship between the main unit and sub-units when all television receivers forming the display set 11 face the front side.

In the example shown in FIG. 3, all the 3×3-television receivers face the front side. Among the 3×3-television receivers, a television receiver 21₁₁ positioned at the bottom left (the first from the left and the third from the top) serves as the main unit, and the other eight television receivers 22₁₂, 22₁₃, 22₂₁, 22₂₂, 22₂₃, 22₃₁, 22₃₂, and 22₃₃ serve as sub-units.

The 3×3-television receivers 21₁₁, 22₁₂, 22₁₃, 22₂₁, 22₂₂, 22₂₃, 22₃₁, 22₃₂, and 22₃₃ are provided with remote controller sensors 31₁₁, 31₁₂, 31₁₃, 31₂₁, 31₂₂, 31₂₃, 31₃₁, 31₃₂, and 31₃₃, respectively, for receiving remote controller commands from the remote controller 12 as infrared or radio waves.

In the example shown in FIG. 3, among the remote controller sensors 31₁₁ through 31₃₃, the remote controller sensor 31₁₁ (indicated by the black square at the first from the left and the third from the top) of the main unit 21₁₁ becomes effective. On the other hand, the remote controller sensors 31₁₂ through 31₃₃ of the sub-units 22₁₂ through 22₃₃, respectively, become ineffective so that they are operated in accordance with a remote controller command sent from the main unit 21₁₁ without receiving the remote controller command sent from the remote controller 12.

When a remote controller sensor is “effective”, it can receive a remote controller command sent from the remote controller 12, and when a remote controller sensor is “ineffective”, it is unable to receive a remote controller command sent from the remote controller 12.

Accordingly, the main unit 21₁₁ receives a remote controller command from the remote controller 12 by the remote controller sensor 31₁₁ and distributes the received remote controller command to the sub-units 22₁₂ through 22₃₃ connected to the main unit 21₁₁ by a LAN conforming with, for example, the Ethernet standards.

In the above-described example, the television receiver 21₁₁ located at the bottom left is used as the main unit. However, any one of the other television receivers 22₁₂ through 22₃₃ may serve as the main unit.

A description is now given, with reference to FIG. 4, of the relationship between the main unit and sub-units when, among the television receivers forming the display set 11, some television receivers face the front side and the other television receivers face the back side. In FIG. 4, elements similar to those in FIG. 3 are designated with like reference numerals, and an explanation thereof is thus omitted.

In the example shown in FIG. 4, among the 3×3-television receivers, the television receivers 21₁₁, 22₁₂, 22₁₃, 22₂₁, 22₃₂, and 22₃₃ face the front side, and the television receivers 22₂₂, 22₂₃, and 21₃₁ face the back side.

Among the television receivers 21₁₁, 22₁₂, 22₁₃, 22₂₁, 22₃₂, and 22₃₃ facing the front side, the television receiver 21₁₁ positioned at the bottom left (the first from the left and the third from the top) serves as the main unit, and the other five television receivers 22₁₂, 22₁₃, 22₂₁, 22₃₂, and 22₃₃ serve as sub-units.

In the example shown in FIG. 4, among the remote controller sensors 31₁₁, 31₁₂, 31₁₃, 31₂₁, 31₃₂, and 31₃₃ of the television receivers 21₁₁, 22₁₂, 22₁₃, 22₂₁, 22₃₂, and 22₃₃ facing the front side, the remote controller sensor 31₁₁ (indicated by the black square at the first from the left and the third from the top) of the main unit 21₁₁ becomes effective so that it can receive a remote controller command sent from the remote controller 12. In contrast, the remote controller sensors 31₁₂, 31₁₃, 31₂₁, 31₃₂, and 31₃₃ of the sub-units 22₁₂, 22₁₃, 22₂₁, 22₃₂, and 22₃₃, respectively, become ineffective so that they are operated in accordance with a remote controller command sent from the main unit 21₁₁ without receiving the remote controller command from the remote controller 12.

That is, the main unit 21₁₁ receives a remote controller command from the remote controller 12 by the remote controller sensor 31₁₁, and distributes the received remote controller command to the sub-units 22₁₂, 22₁₃, 22₂₁, 22₃₂, and 22₃₃ connected to the main unit 21₁₁ by a LAN conforming with, for example, the Ethernet standards.

Among the television receivers 22₂₂, 22₂₃, and 21₃₁ facing the back side, the television receiver 21₃₁ located at the bottom right (the third from the left and the third from the top) serves as the main unit, and the other two television receivers 22₂₂, 22₂₃ serve as sub-units.

In the example shown in FIG. 4, among the remote controller sensors 31₂₂, 31₂₃, and 31₃₁ of the television receivers 22₂₂, 22₂₃, and 21₃₁ facing the back side, the remote controller sensor 31₃₁ (indicated by the black square at the bottom right) of the main unit 21₃₁ becomes effective so that it can receive a remote controller command from the remote controller 12. The remote controller sensors 31₂₂ and 31₂₃ of the sub-units 22₂₂ and 22₂₃, respectively, become ineffective so that they are operated in accordance with a remote controller command sent from the main unit 21₃₁ without receiving the remote controller command from the remote controller 12.

That is, the main unit 21₃₁ receives a remote controller command from the remote controller 12 by the remote controller sensor 31₃₁ and distributes the received remote controller command to the sub-units 22₂₂ and 22₂₃ connected to the main unit 21₃₁ by a LAN conforming with, for example, the Ethernet standards.

In the above-described example, among the television receivers facing the front side, the television receiver 21₁₁ located at the bottom left is used as the main unit. Alternatively, however, any one of the other five television receivers 22₁₂, 22₁₃, 22₂₁, 22₃₂, and 22₃₃ may serve as the main unit. Similarly, among the television receivers facing the back side, the main unit located at the bottom right 21₃₁ is used as the main unit. Alternatively, however, any one of the other two television receivers 22₂₂ and 22₂₃ may serve as the main unit.

Additionally, the number of television receivers forming the display set 11 is not restricted to nine, and any number of television receivers may form the display set 11. The layout of the television receivers forming the display set 11 is not restricted to a 3×3 matrix, as shown in FIGS. 2A through 4, and it may be, for example, a 1×2, 2×1, or 2×3 arrangement. Additionally, the configuration of television receivers is not limited to a matrix, as shown in FIGS. 2A through 4, and may be, for example, a pyramid.

That is, any number of television receivers may be disposed in any configuration (rows and columns) to form the display set 11.

The subscript of the main unit 21ᵢⱼ indicates that the main unit 21ᵢⱼ is located at the i-th column from the left and the j-th row from the bottom in the display set 11. Similarly, the subscript of the sub-unit 22ᵢⱼ indicates that the sub-unit 22ᵢⱼ is located at the i-th column from the left and the j-th row from the bottom in the display set 11. The subscript of the remote controller sensor 31ᵢⱼ indicates that the remote controller sensor 31ᵢⱼ is located at the i-th column from the left and the j-th row from the bottom in the display set 11.

In the following description, when it is not necessary to individually distinguish the main units 21ᵢⱼ, the sub-units 22ᵢⱼ, and the remote controller sensors 31ᵢⱼ, they are simply referred to as the “main unit 21”, “sub-unit 22”, and “remote controller sensor 31”, respectively.

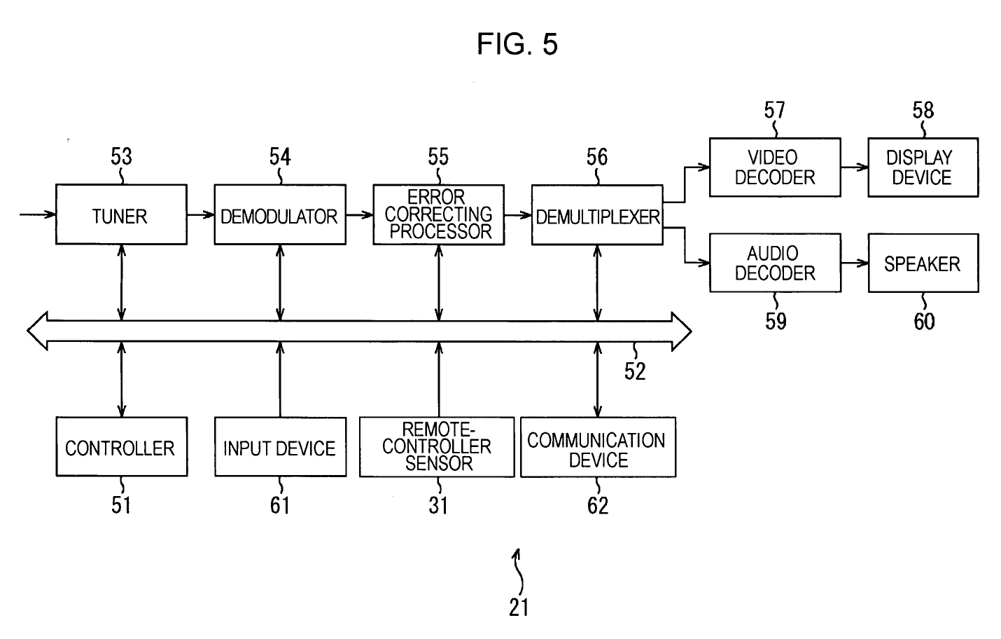

FIG. 5 is a block diagram illustrating an example of the configuration of the main unit 21.

The main unit 21 includes the remote controller sensor 31, a controller 51, a bus 52, a tuner 53, a demodulator 54, an error correcting processor 55, a demultiplexer 56, a video decoder 57, the display device 58, an audio decoder 59, the speaker 60, an input device 61, and a communication device 62. The remote controller sensor 31, the controller 51, the tuner 53, the demodulator 54, the error correcting processor 55, the demultiplexer 56, the input device 61, and the communication device 62 are connected to each other through the bus 52.

Television broadcast signals corresponding to broadcasting radio waves, such as ground waves received by an antenna (not shown) or radio waves from broadcasting satellites, are transmitted to the tuner 53.

Under the control of the controller 51, the tuner 53 selects a broadcast signal of a predetermined channel (frequency) from broadcast signals of a plurality of channels supplied from the antenna, and supplies the broadcast signal of the selected channel to the demodulator 54.

The demodulator 54 demodulates the broadcast signal of the selected channel supplied from the tuner 53 by, for example, quadrature phase shift keying (QPSK) and supplies the demodulated data to the error correcting processor 55.

The error correcting processor 55 performs predetermined error correction on the data supplied from the demodulator 54 under the control of the controller 51, and supplies the data subjected to error correction to the demultiplexer 56.

The demultiplexer 56 descrambles the data supplied from the error correcting processor 55 if necessary under the control of the controller 51, and also divides the data supplied from the error correcting processor 55 into image data and audio data and supplies the image data to the video decoder 57 and the audio data to the audio decoder 59 under the control of the controller 51.

The video decoder 57 decodes the image data supplied from the demultiplexer 56 according to, for example, an MPEG-2 (Moving Picture Experts Group phase 2) method, and supplies the decoded image data to the display device 58, such as a liquid crystal display (LCD) or a cathode ray tube (CRT) display. The display device 58 displays the supplied image data.

The audio decoder 59 decodes the audio data supplied from the demultiplexer 56 according to, for example, an MPEG-2 method, and supplies the decoded audio data to the speaker 60. The speaker 60 outputs the audio data.

The controller 51 controls the individual elements of the main unit 21.

The controller 51 includes a central processing unit (CPU), a read only memory (ROM), a random access memory (RAM), an electrically erasable and programmable ROM (EEPROM), etc. The CPU executes a program stored in the ROM or the EEPROM or a program loaded into the RAM. The ROM stores necessary data and programs executed first by the CPU when the controller 51 is powered ON. The EEPROM stores necessary data and various application programs executed by the CPU. The RAM stores various application programs executed by the CPU and data loaded from the EEPROM, which is necessary for the CPU to operate.

The input device 61, which include switch buttons, receives an operation performed by a viewer when selecting a predetermined channel and supplies an operation signal reflecting the viewer's operation to the controller 51.

The remote controller sensor 31, which corresponds to the remote controller sensor 31 shown in FIG. 3 or 4, receives an operation signal as infrared or radio waves associated with the viewer's operation sent from the remote controller 12, and supplies the received operation signal to the controller 51.

The communication device 62 controls communication with the sub-units 22 under the control of the controller 51, and sends data to the sub-units 22 and receives data from the sub-units 22.

The sub-units 22 are configured similarly to the main unit 21, and an explanation and representation thereof is thus omitted. The internal configuration of the main unit 21 or the sub-units 22 is not restricted to that shown in FIG. 5, and functions may be added or deleted if necessary, in which case, it is possible that the main unit 21 or the sub-units 22 is configured in accordance with the functions thereof.

FIG. 6 is a block diagram illustrating the functional configuration of the main unit 21.

The main unit 21 includes the remote controller sensor 31, the communication device 62, a controller 101, a reception-status history manager 102, and an application processor 103.

The remote controller sensor 31, which corresponds to the remote controller sensor 31 shown in FIG. 3 or 4, receives a remote controller command sent from the remote controller 12 in response to a viewer's operation and supplies the received remote controller command to the controller 101.

The controller 101 supplies the remote controller command sent from the remote controller sensor 31 to the application processor 103.

The controller 101 loads, from the reception-status history manager 102, the number of remote controller commands received from the remote controller 12 within a predetermined period of time (hereinafter simply referred to as the “number of commands”). The controller 101 supplies information concerning the loaded number of commands to the communication device 62.

The controller 101 includes a position-information obtaining portion 111, an orientation-information obtaining portion 112, a distributor determining portion 113, a mode controller 114, and an orientation information adder 115.

The position-information obtaining portion 111 obtains information concerning the position at which the television receiver shown in FIG. 6 is positioned in the display set 11 (hereinafter referred to as the “position information”). The position-information obtaining portion 111 supplies the obtained position information to the distributor determining portion 113 or the communication device 62.

The orientation-information obtaining portion 112 obtains information indicating whether the television receiver shown in FIG. 6 faces the front side or the back side of the display set 11 (hereinafter referred to as the “orientation information”). The orientation-information obtaining portion 112 supplies the obtained orientation information to the distributor determining portion 113, the orientation information adder 115, or the communication device 62.

The distributor determining portion 113 determines, based on the position information and orientation information concerning the television receiver shown in FIG. 6 and position information and orientation information concerning other television receivers supplied from the communication device 62, whether the television receiver shown in FIG. 6 serves as the distributor of remote controller commands (main unit 21).

The distributor determining portion 113 also determines, based on the number of commands and orientation information concerning the television receiver shown in FIG. 6 and the numbers of commands and orientation information concerning the other television receivers supplied from the communication device 62, whether the television receiver shown in FIG. 6 serves as the distributor of remote controller commands (main unit 21).

The mode controller 114 controls the mode of the television receiver shown in FIG. 6 based on the determination result obtained by the distributor determining portion 113.

The “mode” indicates whether the television receiver forming the display set 11 operates as the main unit 21 or a sub-unit 22. If the mode is the “command distributor mode”, the television receiver operates as the main unit 21, and if the mode is the “command receiver mode”, the television receiver operates as the sub-unit 22.

The orientation information adder 115 adds the orientation information supplied from the orientation-information obtaining portion 112 to a remote controller command received from the remote controller sensor 31, and then supplies the remote controller command provided with the orientation information to the communication device 62.

The communication device 62, which corresponds to the communication device 62 shown in FIG. 5, communicates with the other television receivers (sub-units 22).

The communication device 62 includes a transmitter 121 for transmitting various data and a receiver 122 for receiving various data. The transmitter 121 transmits position information and orientation information supplied from the controller 101 to the other television receivers (sub-units 22) by broadcast communication. The receiver 122 receives position information and orientation information from the other television receivers (sub-units 22), and supplies the received position information and orientation information to the controller 101.

The transmitter 121 also transmits the orientation information and information concerning the number of commands supplied from the controller 101 to the other television receivers (sub-units 22) by broadcast communication. The receiver 122 also receives the orientation information and information concerning the number of commands from the other television receivers (sub-units 22), and supplies the received orientation information and information concerning the number of commands to the controller 101.

The transmitter 121 also transmits a remote controller command provided with orientation information supplied from the controller 101 to the other television receivers (sub-units 22) by broadcast communication.

The communication device 62 may receive, together with data transmitted from the other television receivers, the IDs of the other television receivers.

In response to a request from the controller 101, the reception-status history manager 102 supplies information concerning the number of commands, which is stored in the reception-status history manager 102, to the controller 101.

When the remote controller sensor 31 receives a remote controller command, the reception-status history manager 102 counts up the number of command under the control of the controller 101.

The application processor 103 executes predetermined processing based on a remote controller command supplied from the controller 101.

FIG. 7 is a block diagram illustrating the functional configuration of the sub-unit 22.

The sub-unit 22 includes the remote controller sensor 31, the communication device 62, the controller 101, the reception-status history manager 102, and the application processor 103.

In FIG. 7, elements similar to those shown in FIG. 6 are designated with like reference numerals, and an explanation thereof is thus omitted.

The communication device 62, which corresponds to the communication device 62 shown in FIG. 5, communicates with the other television receivers (main unit 21 or sub-units 22).

The communication device 62 includes the transmitter 121 for transmitting various data and the receiver 122 for receiving various data. The transmitter 101 transmits position information and orientation information supplied from the controller 101 to the other television receivers (main unit 21 or sub-units 22) by broadcast communication. The receiver 122 receives position information and orientation information sent from the other television receivers (main unit 21 or sub-units 22), and supplies the received position information and orientation information to the controller 101.

The transmitter 121 also transmits orientation information and number-of-command information supplied from the controller 101 to the other television receivers (main unit 21 or sub-units 22) by broadcast communication. The receiver 122 also receives orientation information and number-of-command information sent from the other television receivers (main unit 21 or sub-units 22), and supplies the received information to the controller 101.

If the receiver 122 receives a remote controller command from another television receiver (main unit 21), it supplies the received command to the controller 101.

The controller 101 includes the position-information obtaining portion 111, the orientation-information obtaining portion 112, the distributor determining portion 113, the mode controller 114, and an orientation-information determining portion 161.

The position-information obtaining portion 111, the orientation-information obtaining portion 112, the distributor determining portion 113, and the mode controller 114 correspond to the counterparts of the main unit 21 shown in FIG. 6, and an explanation thereof is thus omitted.

The orientation-information determining portion 161 compares the orientation information supplied from the orientation-information obtaining portion 112 with the orientation information added to the remote controller command supplied from the main unit 21 via the communication device 62 to determine whether the main unit 21 faces in the same orientation as the sub-unit 22 shown in FIG. 7.

If the orientation-information determining portion 161 determines that the main unit 21 faces in the same orientation as the sub-unit 22, the application processor 103 executes predetermined processing in accordance with the remote controller command supplied from the controller 101.

As discussed above, among the television receivers facing the front side and those facing the back side, the remote controller sensor 31 of the main unit 21 which becomes effective and the remote controller sensors 31 of the sub-units 22 which become ineffective are determined.

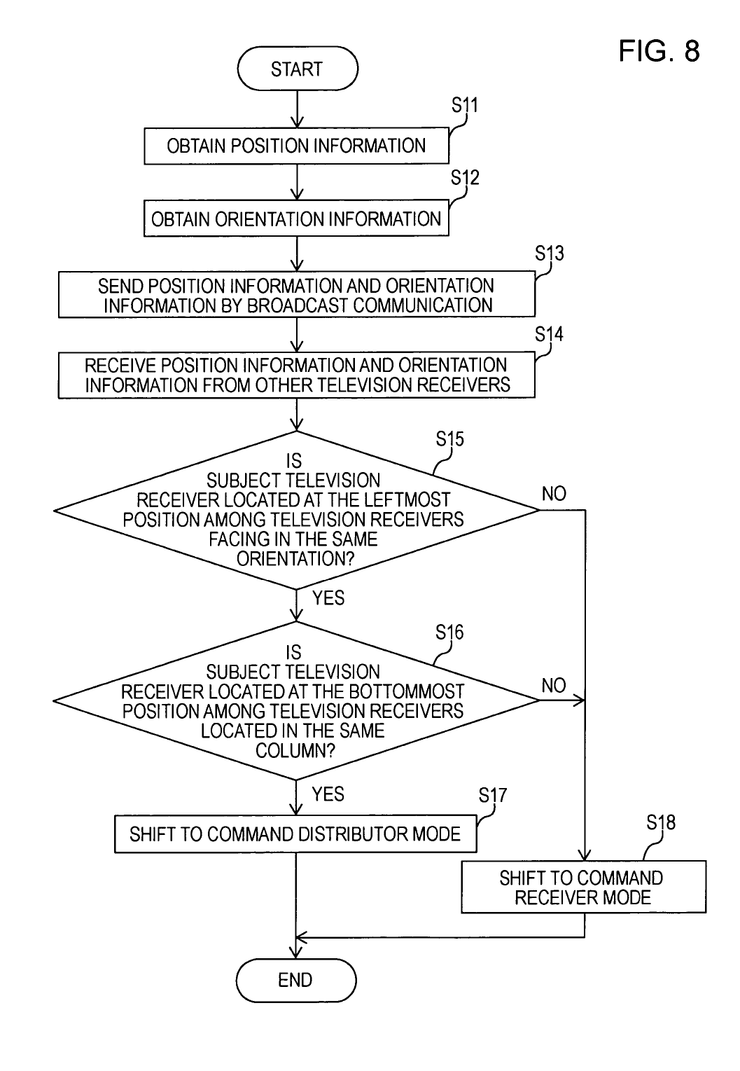

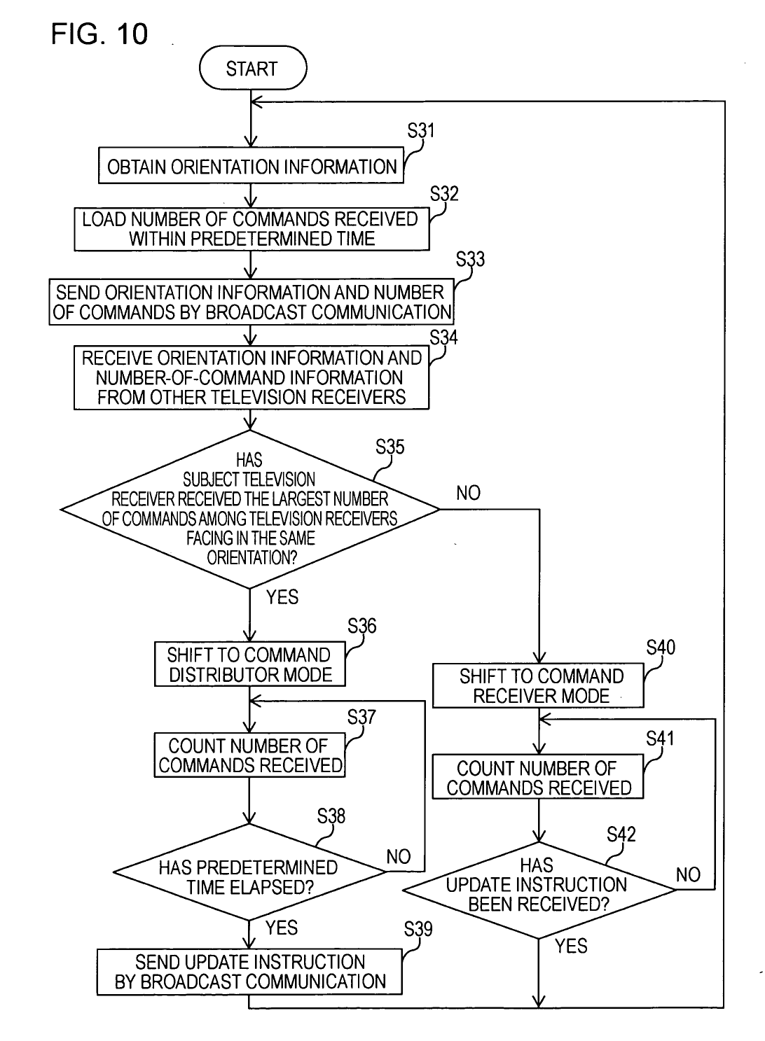

A description is now given of command distributor determining processing for determining the television receiver having the remote controller sensor 31 to be effective, i.e., the main unit 21 (remote controller command distributor), with reference to the flowcharts in FIGS. 8 and 10.

The command distributor determining processing is equally performed in all television receivers forming the display set 11. Accordingly, the command distributor determining processing performed in the television receiver 21₁₁ operating as the main unit 21 in FIG. 4 is discussed by way of example, and the command distributor determining processing performed in the other television receivers 22₁₂ through 22₃₃ is omitted.

Reference is first given to FIG. 8 to discuss command distributor determining processing performed by the television receiver 21₁₁.

In step S11, the position-information obtaining portion 111 obtains position information indicating the position of the television receiver 21₁₁ in the display set 11, and supplies the obtained position information to the communication device 62. For example, in step S11, the position-information obtaining portion 111 obtains position information indicating that the television receiver 21₁₁ is positioned at the bottom left (the first from the left and the third from the top in FIG. 4), and supplies the obtained position information to the communication device 62.

Then, in step S12, the orientation-information obtaining portion 112 obtains orientation information indicating whether the television receiver 21₁₁ faces the front side or the back side of the display set 11, and supplies the obtained orientation information to the communication device 62. For example, in step S12, the orientation-information obtaining portion 112 obtains orientation information indicating that the television receiver 21₁₁ faces the front side, and supplies the obtained orientation information to the communication device 62.

The position information and orientation information may be obtained in any manner as long as the television receivers can obtain the information. For example, a sensor (not shown) disposed on the display set 11 may detect the positions and orientations of the television receivers combined as the display set 11 to allow the television receivers to obtain the corresponding position information and orientation information.

In step S13, the communication device 62 transmits the position information supplied from the position-information obtaining portion 111 and the orientation information supplied from the orientation-information obtaining portion 112 to the other television receivers by broadcast communication. For example, in step S13, the communication device 62 transmits the position information, indicating that the television receiver 21₁₁ is located at the position the first from the left and the third from the top in the display set 11, and the orientation information, indicating that the television receiver 21₁₁ faces the front side, to the television receivers 22₁₂, 22₁₃, 22₂₁, 22₂₂, 22₂₃, 22₃₁, 22₃₂, and 22₃₃ by broadcast communication.

In step S14, the communication device 62 receives the position information and orientation information sent from the other television receivers, and supplies the received position information and orientation information to the distributor determining portion 113.

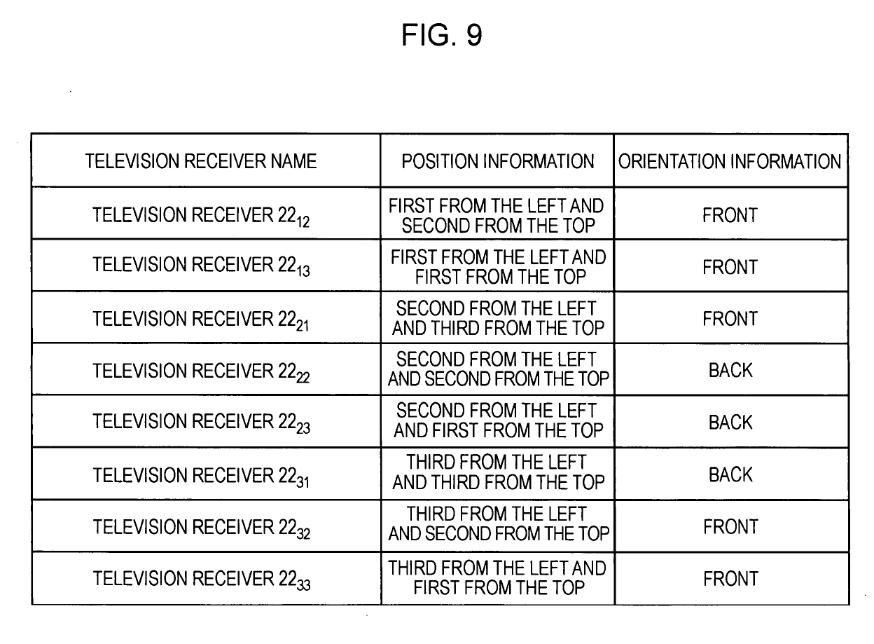

FIG. 9 illustrates an example of the position information and orientation information sent from the other television receivers.

In the example shown in FIG. 9, the first row indicates the fields, and the second and subsequent rows indicate position information data and orientation information data sent from the other television receivers. The first, second, and third columns designate the television receiver name, position information, and orientation information, respectively. That is, in the example shown in FIG. 9, the position information and orientation information are indicated in association with the other television receivers.

The second row indicates that the television receiver 22₁₂ is located at the position the first from the left and the second from the top in the display set 11 and faces the front side of the display set 11. Similarly, the third row indicates that the television receiver 22₁₃ is located at the position the first from the left and the first from the top in the display set 11 and faces the front side of the display set 11.

Likewise, the fourth row indicates that the television receiver 22₂₁ is located at the position the second from the left and the third from the top in the display set 11 and faces the front side of the display set 11. The fifth row indicates that the television receiver 22₂₂ is located at the position the second from the left and the second from the top in the display set 11 and faces the back side of the display set 11. The sixth row indicates that the television receiver 22₂₃ is located at the position the second from the left and the first from the top in the display set 11 and faces the back side of the display set 11.

Similarly, the seventh row indicates that the television receiver 22₃₁ is located at the position the third from the left and the third from the top in the display set 11 and faces the back side of the display set 11. The eighth row indicates that the television receiver 22₃₂ is located at the position the third from the left and the second from the top in the display set 11 and faces the front side of the display set 11. The ninth row indicates that the television receiver 22₃₃ is located at the position the third from the left and the first from the top in the display set 11 and faces the front side of the display set 11.

Referring back to the flowchart in FIG. 8, in step S14, the communication device 62 receives position information and orientation information (FIG. 9) sent from the television receivers 22₁₂, 22₁₃, 22₂₁, 22₂₂, 22₂₃, 22₃₁, 22₃₂, and 22₃₃, and supplies the received position information and orientation information to the distributor determining portion 113.

Then, in step S15, the distributor determining portion 113 determines, based on the position information and orientation information concerning the subject television receiver (in this case, the main unit 21) and the position information and orientation information concerning the other television receivers supplied from the communication device 62, whether the subject television receiver is located at the leftmost position among the television receivers facing in the same orientation (i.e., the front side).

For example, in step S15, the distributor determining portion 113 determines whether the subject television receiver is located at the leftmost position among the television receivers facing in the same orientation by comparing the position information indicating that the subject television receiver is located at the first from the left and the third from the top obtained in step S11 and the orientation information indicating that the subject television receiver faces the front side obtained in step S12 with the position information and orientation information (FIG. 9) concerning the other television receivers received in step S14.

If it is determined in step S15 that the subject television receiver is located at the leftmost position, the distributor determining portion 113 proceeds to step S16 to determine whether the subject television receiver is located at the bottommost position among the television receivers positioned in the same column.

For example, since it can be determined in step S15 that, among the television receivers facing the front side, the television receiver 21₁₁ is located at the leftmost position as well as the television receivers 22₁₂ and 22₁₃, the process proceeds to step S16.

It can also be determined in step S15 that the television receiver 21₃₁ is located at the leftmost position among the television receivers facing the back side. Accordingly, the process proceeds to step S16.

If it is determined in step S16 that the subject television receiver is located at the bottommost position among the television receivers positioned in the same column, the process proceeds to step S17. In step S17, the mode controller 114 shifts the mode of the subject television receiver to the command distributor mode in which remote controller commands from the remote controller 12 are distributed to the sub-units 22. The processing is then completed.

For example, since it can be determined in step S16 that the television receiver 21₁₁ is located farther downward than the television receivers 22₁₂ and 22₁₃ among the television receivers facing the front side and located at the leftmost position, the process proceeds to step S17. In step S17, the mode controller 114 shifts the mode of the television receiver 21₁₁ to the command distributor mode, that is, the television receiver 21₁₁ serves as the main unit 21. The process is then completed.

It can also be determined in step S16 that the television receiver 21₃₁ is located at the bottommost position among the television receivers facing the back side and located at the leftmost position. Accordingly, the process proceeds to step S17 in which the mode controller 114 shifts the mode of the television receiver 2131 to the command distributor mode, that is, the television receiver 21₃₁ serves as the main unit 21. The processing is then completed.

If it is determined in step S15 that the subject television receiver is not located at the leftmost position among the television receivers facing in the same orientation, or if it is determined in step S16 that the subject television receiver is not located at the bottommost position among the television receivers positioned in the same column, the process proceeds to step S18. In step S18, the mode controller 114 shifts the mode of the subject television receiver to the command receiver mode. The processing is then completed.

For example, since none of the television receivers 22₁₂, 22₁₃, 22₂₁, 22₂₂, 22₂₃, 22₃₂, and 22₃₃ satisfies the conditions that the corresponding television receiver is located at the leftmost position among the television receivers facing in the same orientation and is located at the bottommost position among the television receivers positioned in the same column, the process proceeds from step S15 to step S18 in which the mode controller 114 shifts the mode of the corresponding television receiver to the command receiver mode, that is, the television receiver serves as the sub-unit 22. The processing is then completed.

As discussed above, the television receiver operating as the main unit 21 can be determined by the position and orientation at which the subject television receiver is installed. Accordingly, even when programs are watched on either side, i.e., the front side or the back side, by turning over or removing some television receivers of the display set 11, remote controller commands from the remote controller 12 can be reliably received.

The command distributor determining processing shown in FIG. 8 may be performed at certain timing, for example, when some television receivers are turned over or removed or when a predetermined period of time has elapsed.

In the command distributor determining processing shown in FIG. 8, the command distributor (main unit 21) is statically determined by the position at which the subject television receiver is installed. Alternatively, the command distributor may be determined dynamically by the number of remote controller commands received from the remote controller 12.

A description is now given, with reference to the flowchart in FIG. 10, of the command distributor determining processing performed by the television receiver 2111 for determining the command distributor (main unit 21) according to the number of commands.

In step S31, the orientation-information obtaining portion 112 obtains orientation information concerning the subject television receiver, and supplies the received orientation information to the communication device 62. For example, in step S31, the orientation-information obtaining portion 112 obtains orientation information indicating that the subject television receiver faces the front side, and supplies the obtained orientation information to the communication device 62.

In step S32, the controller 101 loads, from the reception-status history manager 102, the number of commands received within a predetermined period of time, and supplies information concerning the number of commands (number-of-command information) to the communication device 62. If one hour has elapsed after the previous number of commands are loaded from the reception-status history manager 102, the controller 101 loads the number of commands, for example, 20, and supplies the number-of-command information to the communication device 62.

That is, in this case, regardless of whether the television receiver 21₁₁ operates in the command distributor mode (main unit 21) or the command receiver mode (sub-unit 22), the television receiver 21₁₁ monitors the reception status indicating whether a remote controller command is received from the remote controller 12. If a remote controller command is received, the television receiver 21₁₁ counts up the number of commands stored in the reception-status history manager 102.

In step S33, the communication device 62 sends the orientation information supplied from the orientation-information obtaining portion 112 and the number-of-command information supplied from the controller 101 to the other television receivers by broadcast communication. For example, in step S33, the communication device 62 sends the orientation information indicating that the television receiver 2111 faces the front side and the number-of-command information “20” to the television receivers 22₁₂, 22₁₃, 22₂₁, 22₂₂, 22₂₃, 22₃₁, 22₃₂, and 22₃₃ by broadcast communication.

In step S34, the communication device 62 receives position information and number-of-command information supplied from the other television receivers, and supplies the received information to the distributor determining portion 113.

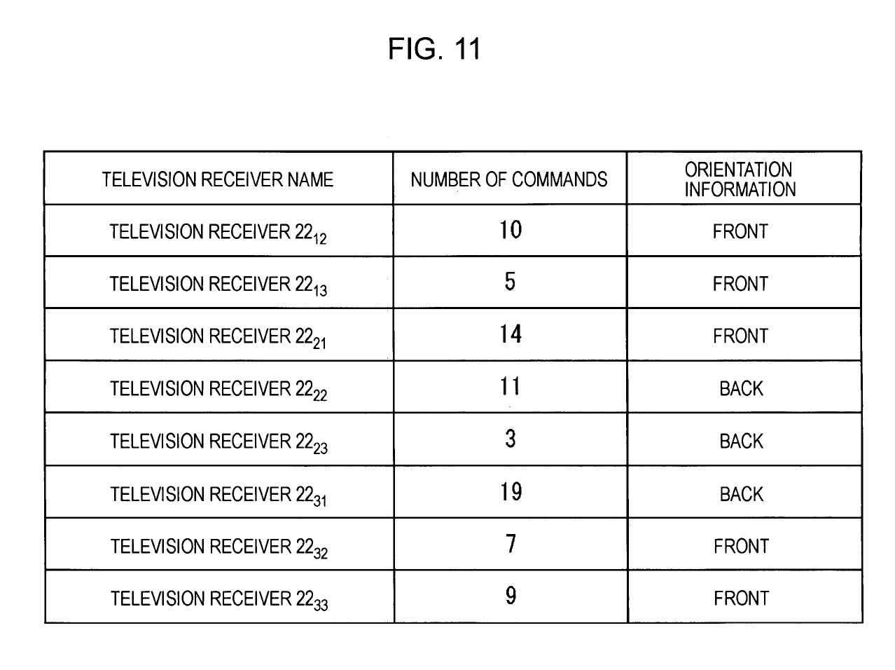

FIG. 11 illustrates an example of orientation information and number-of-command information sent from the other television receivers.

In the example shown in FIG. 11, the first row indicates the fields, and the second row and the subsequent rows designate number-of-command information data and orientation information data sent from the other television receivers. The first, second, and third columns designate the television receiver name, number of commands, and orientation information, respectively. That is, in the example shown in FIG. 11, the number of commands and orientation information are indicated in association with the other television receiver names.

The second row from the top indicates that the television receiver 22₁₂ facing the front side of the display set 11 has received 10 remote controller commands (10 times) within a predetermined period of time (for example, one hour). Similarly, the third row from the top indicates that the television receiver 22₁₃ facing the front side of the display set 11 has received 5 remote controller commands (5 times) within a predetermined period of time (for example, one hour).

Likewise, the fourth row from the top indicates that the television receiver 22₂₁ facing the front side of the display set 11 has received 14 remote controller commands (14 times) within a predetermined period of time (for example, one hour). The fifth row from the top indicates that the television receiver 22₂₂ facing the back side of the display set 11 has received 11 remote controller commands (11 times) within a predetermined period of time (for example, one hour). The sixth row from the top indicates that the television receiver 22₂₃ facing the back side of the display set 11 has received 3 remote controller commands (3 times) within a predetermined period of time (for example, one hour).

Similarly, the seventh row from the top indicates that the television receiver 22₃₁ facing the back side of the display set 11 has received 19 remote controller commands (19 times) within a predetermined period of time (for example, one hour). The eighth row from the top indicates that the television receiver 22₃₂ facing the front side of the display set 11 has received 7 remote controller commands (7 times) within a predetermined period of time (for example, one hour). The ninth row from the top indicates that the television receiver 22₃₃ facing the front side of the display set 11 has received 9 remote controller commands (9 times) within a predetermined period of time (for example, one hour).

Referring back to the flowchart in FIG. 10, in step S34, the communication device 62 receives the number-of-command information and orientation information (FIG. 11) sent from the television receivers 22₁₂, 22₁₃, 22₂₁, 22₂₂, 22₂₃, 22₃₁, 22₃₂, and 22₃₃, and supplies the received information to the distributor determining portion 113.

In step S35, the distributor determining portion 113 determines, based on the number-of-command information and orientation information concerning the subject television receiver and the number-of-command information and orientation information concerning the other television receiver supplied from the communication device 62, whether the subject television receiver has received the largest number of commands among the television receivers facing in the same orientation.

For example, in step S35, the distributor determining portion 113 determines whether the subject television receiver has received the largest number of commands among the television receivers facing in the same orientation by comparing the orientation information, indicating that the subject television receiver faces the front side, obtained in step S31 and the number of commands “20” obtained in step S32 with the number of commands and orientation information (FIG. 11) concerning the other television receivers.

If it is determined in step S35 that the subject television receiver has received the largest number of commands among the television receivers facing in the same orientation, the process proceeds to step S36. In step S36, the mode controller 14 shifts the mode of the subject television receiver to the command distributor mode in which remote controller commands from the remote controller 12 are distributed to the sub-units 22.

For example, it can be determined in step S35 that the television receiver 21₁₁ has received the largest number of commands, i.e., 20 remote controller commands (20 times), within a predetermined period of time (one hour) among the television receivers 21₁₁, 22₁₂, 22₁₃, 22₂₁, 22₃₂, and 22₃₃ facing the front side. Accordingly, the process proceeds to step S36 in which the mode of the television receiver 21₁₁ is shifted to the command distributor command, that is, the television receiver 21₁₁ serves as the main unit 21.

In step S37, the reception-status history manager 102 counts up the number of commands received by the subject television receiver. For example, upon receiving a remote controller command indicating “channel switching” from the remote controller 12 after the viewer presses the channel switch button of the remote controller 12 toward the television receivers facing the front, the remote controller sensor 31 of the television receiver 21₁₁ supplies the received remote controller command to the controller 101. The controller 101 executes the processing in accordance with the remote controller command indicating “channel switching”, and also informs the reception-status history manager 102 of the receipt of the remote controller command so that the reception-status history manager 102 can count up the number of commands.

In step S38, the reception-status history manager 102 determines whether a predetermined period of time has elapsed.

If it is determined in step S38 that the predetermined period of time has not elapsed, the process returns to step S37, and steps S37 and S38 are repeated. That is, the television receiver 21₁₁ continues counting up remote controller commands sent from the remote controller 12 until the predetermined period of time elapses.

If it is determined in step S38 that the predetermined period of time has elapsed, the process proceeds to step S39. In step S39, the reception-status history manager 102 controls, via the controller 101, the communication deice 62 to send an update instruction to the other television receivers (sub-units 22) by broadcast communication, and returns to step S31, and the above-described processing is repeated.

The “update instruction” is an instruction, which is sent from the television receiver (main unit 21) operating in the command distributor mode to the television receivers (sub-units 22) operating in the command receiver mode, to execute processing (command distributor determining processing shown in FIG. 10) for determining the main unit 21, which serves as the command distributor, by the number of commands received from the remote controller 12. That is, the television receiver received the largest number of commands when an update instruction is sent, becomes the main unit 21. In other words, the television receiver which serves as the main unit 21 is dynamically changing depending on the number of commands.

If it is determined in step S35 that the subject television receiver has not received the largest number of commands among the television receivers facing in the same orientation, the process proceeds to step S40. In step S40, the mode controller 114 shifts the mode of the subject television receiver to the command receiver mode.

For example, it can be determined in step S35 that the numbers of commands received by the television receivers 22₁₂, 22₁₃, 22₂₁, 22₃₂, and 22₃₃ within the predetermined period of time (one hour) are smaller than 20. Accordingly, the process proceeds to step S36 in which the modes of the television receivers 22₁₂, 22₁₃, 22₂₁, 22₃₂, and 22₃₃ are shifted to the command receiver mode, that is, the television receivers 22₁₂, 22₁₃, 22₂₁, 22₃₂, and 22₃₃ become the sub-units 22.

In step S41, the reception-status history manager 102 counts up the number of commands received by the subject television receiver. For example, upon receiving a remote controller command to switch the channel from the remote controller 12 after the viewer presses the channel switch button of the remote controller 12 toward the television receivers facing the front side, the remote controller sensor 31 of each of the television receivers 22₁₂, 22₁₃, 22₂₁, 22₃₂, and 22₃₃ supplies the received remote controller command to the controller 101. The controller 101 executes the processing in accordance with the received remote controller command to switch the channel, and also informs the reception-status history manager 102 of the receipt of the remote controller command so that the reception-status history manager 102 can count up the number of commands.

In step S42, the reception-status history manager 102 determines whether an update instruction has been received from the main unit 21 via the controller 101. This determination is made based on, for example, an update instruction received from the main unit 21 by the communication device 62 and supplied via the controller 101.

If it is determined in step S42 that an update instruction has not been received, the process returns to step S41 in which the reception-status history manager 102 continues counting up the number of commands sent from the remote controller 12 until an update instruction is received.

If it is determined in step S42 that an update instruction has been received, the process returns to step S31, and step S31 and the subsequent steps are repeated. More specifically, if the television receiver 21₁₁ has received an update instruction from the main unit 21, processing (command distributor determining processing shown in FIG. 10) for determining the main unit 21, which serves as the command distributor, by the number of commands received from the remote controller 12 is re-executed for determining which television receiver serves as the main unit 21 in the same group.

As discussed above, the reception status of remote controller commands sent from the remote controller 12 within a predetermined past period of time is monitored, and the television receiver having the best reception status is determined as the main unit 21. Accordingly, even if the reception status of remote controller commands changes in response to a change of the position of the viewer, instructions from the remote controller 12 can be reliably received.

The command distributor determining processing has been discussed with reference to FIGS. 8 through 11, assuming that the television receiver 21₁₁, which serves as the main unit 21, executes the processing. However, this is an example only. Another television receiver, which is the sub-unit 22, may equally execute the processing. In this case, in the command distributor determining processing in FIG. 8 or 10, the processing operations performed by the position-information obtaining portion 111, the orientation-information obtaining portion 112, the distributor determining portion 113, and the mode controller 114 of the main unit 21 are performed by the counterparts of the sub-unit 22.

Command distribution processing performed by the main unit 21 is described below with reference to the flowchart in FIG. 12.

In step S51, the controller 101 determines based on a remote controller command supplied from the remote controller sensor 31 whether a remote controller command has been received from the remote controller 12. For example, the controller 101 determines whether a remote controller command has been received from the remote controller 12 based on a remote controller command received from the remote controller 12 by the remote controller sensor 31.

If it is determined in step S51 that a remote controller command has not been received from the remote controller 12, the controller 101 returns to step S51 to repeat step S51. That is, the main unit 21 waits until a remote controller command is received from the remote controller 12.

If it is determined in step S51 that a remote controller command has been received, the process proceeds to step S52. In step S52, the orientation-information obtaining portion 112 obtains orientation information concerning the main unit 21 and supplies the obtained orientation information to the orientation information adder 115. For example, in step S52, the orientation-information obtaining portion 112 obtains orientation information indicating that the main unit 21 faces the front side and supplies the orientation information to the orientation information adder 115.

In response to a remote controller command sent from the remote controller 12, the remote controller sensor 31 supplies the received remote controller command to the controller 101. The controller 101 then supplies the remote controller command to the application processor 103.

For example, upon receiving a remote controller command to switch the channel from the remote controller 12 after the viewer presses the channel switch button of the remote controller 12 toward the television receivers facing the front side, the remote controller sensor 31 supplies the received remote controller command to the controller 101. The controller 101 then supplies the received remote controller command to the application processor 103.

In step S53, the orientation information adder 115 adds the orientation information supplied from the orientation-information obtaining portion 112 to the remote controller command supplied from the remote controller sensor 31. The orientation information adder 115 then supplies the remote controller command provided with the orientation information to the communication device 62.

FIG. 13A illustrates an example of a remote controller command without orientation information, and FIG. 13B illustrates an example of a remote controller command with orientation information.

A front/back flag is added to the remote controller command shown in FIG. 13B as the orientation information. The front/back flag indicates whether the subject television receiver faces the front side or the back side by 0 or 1. When the subject television receiver faces the front side, 0 is added to the remote controller command, and when the subject television receiver faces the back side, 1 is added to the remote controller command.

The front/back flag is only an example of orientation information added to a remote controller command.

Referring back to the flowchart in FIG. 12, in step S53, for example, based on the orientation information, indicating that the main unit 21 faces the front side, supplied from the orientation-information obtaining portion 112 and the remote controller command indicating the channel switching supplied from the remote controller sensor 31, the orientation information adder 115 adds the front/back flag (front) to the remote controller command, and supplies the remote controller command provided with the front/back flag to the communication device 62.

In step S54, the communication device 62 sends the remote controller command provided with the orientation information to the other television receivers (sub-units 22) by broadcast communication.

For example, the communication device 62 of the television receiver 21₁₁ (main unit 21₁₁) sends the remote controller command to switch the channel provided with the front/back flag (front) to the television receivers 22₁₂, 22₁₃, 22₂₁, 22₂₂, 22₂₃, 22₃₁, 22₃₂, and 22₃₃.

In step S55, the application processor 103 executes the remote controller command supplied from the controller 101, and the process returns to step S51 and steps S51 through S55 are repeated.

For example, in step S55, the application processor 103 controls the tuner 53 to change the broadcast signal to the channel desired by the viewer and changes the program displayed on the display device 58 in accordance with the remote controller command supplied from the controller 101.

As described above, the main unit 21 adds orientation information concerning the main unit 21 to a remote controller command sent from the remote controller 12, and sends the remote controller command provided with the orientation information to the sub-units 22. Accordingly, among remote controller commands received from the remote controller 12, the sub-units 22 can interpret and execute, on the basis of the orientation information added to the remote controller commands, remote controller commands only from the main unit 21 facing in the same orientation as the sub-units 22. As a result, the sub-units 22 can reliably execute remote controller commands from the remote controller 12.

Command reception processing performed by the sub-unit 22 is described below with reference to the flowchart in FIG. 14.

In step S71, the controller 101 determines whether a remote controller command has been received from the main unit 21. For example, the controller 101 determines whether a remote controller command has been received from the main unit 21 based on a remote controller command supplied from the main unit 21 via the communication device 62.

If it is determined in step S71 that a remote controller command has not been received, the process returns to step S71 and step S71 is repeated. That is, the sub-unit 22 waits until a remote controller command is received from the main unit 21.

If it is determined in step S71 that a remote controller command has been received, the process proceeds to step S72. In step S72, the orientation-information obtaining portion 112 obtains orientation information concerning the sub-unit 22 and supplies the orientation information to the orientation-information determining portion 161. For example, in step S72, the orientation-information obtaining portion 112 obtains orientation information indicating that the sub-unit 22 faces the front side and supplies the information to the orientation-information determining portion 161.

In response to a remote controller command from the main unit 21, the communication device 62 supplies the remote controller command to the controller 101. The controller 101 then supplies the received remote controller command to the application processor 103.

For example, upon receiving a remote controller command to switch the channel after the viewer presses the channel switch button of the remote controller 12 toward the television receivers facing the front side, the communication device 62 receives the remote controller command having a front/back flag (front) from the main unit 21 and supplies the remote controller command to the controller 101. The controller 101 then supplies the remote controller command having the front/back flag to the application processor 103.

In step S73, the orientation-information determining portion 161 determines whether the main unit 21 faces in the same orientation as the sub-unit 22 by comparing the orientation information supplied from the orientation-information obtaining portion 112 with the orientation information added to the remote controller command supplied from the communication device 62.

If it is determined in step S73 that the main unit 21 faces in the same orientation as the sub-unit 22, the process proceeds to step S74. In step S74, the application processor 103 executes the remote controller command supplied from the controller 101. The process then returns to step S71 and steps S71 through S74 are repeated.

For example, concerning the television receiver 22₁₂, 22₁₃, 22₂₁, 22₃₂, or 22₃₃ facing the front side as the television receiver 21₁₁ (main unit 21₁₁) of the display set 11 shown in FIG. 4, the orientation-information determining portion 161 determines in step S73 that the television receiver 22 faces in the same orientation as the main unit 21 by comparing the orientation information, indicating that the television receiver 22 faces the front side, supplied from the orientation-information obtaining portion 112 with the front/back flag (orientation information) added to the remote controller command to switch the channel supplied from the communication device 62. Thus, the process proceeds to step S74 in which the application processor 103 controls the tuner 53 to change the broadcast signal to the channel desired by the viewer and changes the program displayed on the display device 58 in accordance with the remote controller command supplied from the controller 101.

On the other hand, if it is determined in step S73 that the main unit 21 does not face in the same orientation as the television receiver 22, it is not necessary to execute the remote controller command since the command is targeted for the television receivers facing in the reverse orientation. Accordingly, the process returns to step S71, and steps S71 through S73 are repeated.

For example, concerning the television receiver 22₂₂, 22₂₃, or 22₃₁ facing the side opposite to the television receiver 21₁₁ (main unit 21₁₁) of the display set 11 shown in FIG. 4, the orientation-information determining portion 161 determines in step S73 that the television receiver 22 faces in the orientation opposite to the main unit 21 by comparing the orientation information, indicating that the television receiver 22 faces the back side, supplied from the orientation-information obtaining portion 112 with the front/back flag (orientation information) added to the remote controller command to switch the channel supplied from the communication device 62. Thus, the application processor 103 does not execute the remote controller command. The process then returns to step S71, and steps S71 through S73 are repeated.

That is, before executing a remote controller command sent from the remote controller 12, the sub-unit 22 can determine whether it is necessary to execute the remote controller command based on the orientation information added to the command by the main unit 21 (command distributor).

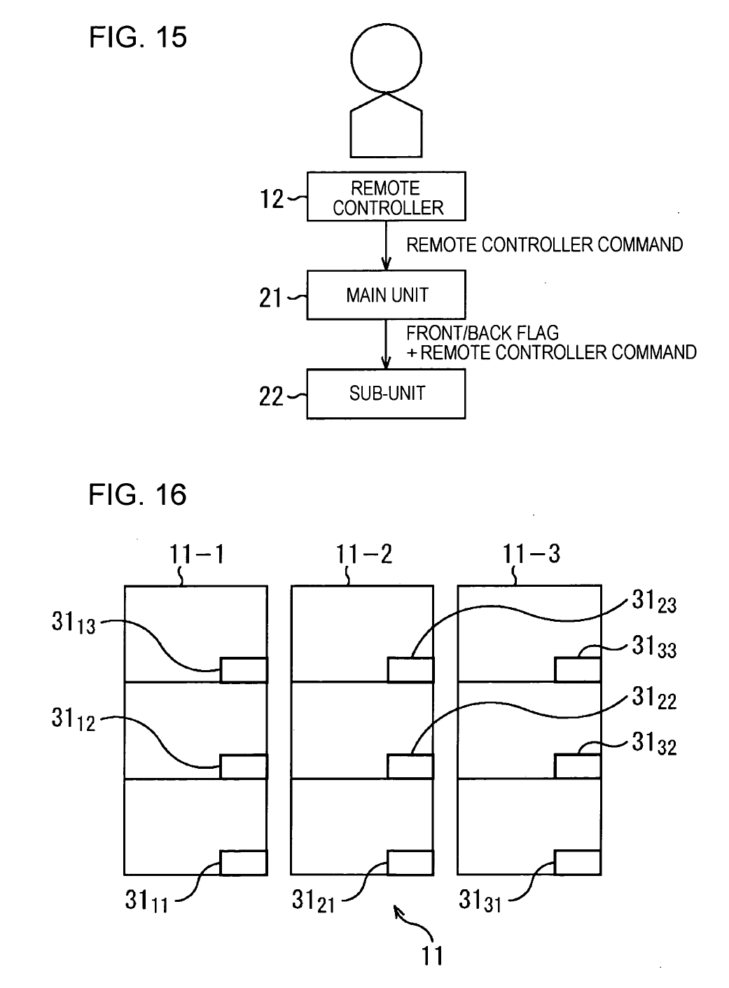

Remote controller commands sent and received among the remote controller 12, the main unit 21, and the sub-units 22 are described below with reference to FIG. 15.

In the example shown in FIG. 15, when the viewer presses a button of the remote controller 12, the main unit 21 receives a remote controller command reflecting the viewer's operation from the remote controller 12, and adds the front/back flag (orientation information) concerning the orientation of the main unit 21 to the received remote controller command, and then transmits the remote controller command having the front/back flag to the sub-unit 22. This processing by the main unit 21 may be the command distribution processing shown in FIG. 12.

Based on the remote controller command having the front/back flag sent from the main unit 21, the sub-unit 22 determines whether the main unit 21 faces in the same orientation as the sub-unit 22. If the main unit 21 faces in the same orientation as the sub-unit 22, the sub-unit 22 executes processing in accordance with the remote controller command. If the main unit 21 does not face in the same orientation as the sub-unit 22, the sub-unit 22 does not execute the remote controller command. This processing performed by the sub-unit 22 may be the command reception processing shown in FIG. 14.

In this manner, upon receiving a remote controller command provided with orientation information from the main unit 21, the sub-unit 22 can interpret and execute the remote controller command only when the main unit 21 faces in the same orientation as the sub-unit 22. As a result, the sub-unit 22 can reliably execute remote controller commands sent from the remote controller 12.

Instead of dividing television receivers into the main unit and sub-units, there is another approach to receiving remote controller commands reliably from the remote controller 12 when viewing programs on either side of the display set 11. For example, by using a signal medium which is necessary to be received from the front, such as infrared signals, only the television receivers facing the front when viewed from the viewer can receive remote controller commands, and the television receivers facing the back side cannot receive remote controller commands.

In this case, unlike the above-described example in which television receivers are used as either the main unit 21 or the sub-unit 22, television receivers combined as the display set 11 serve as neither the main unit 21 nor the sub-unit 22, and the remote controller sensors 31 of all the television receivers become effective.

FIG. 16 illustrates an example of the display set 11 provided with remote controller sensors 31.

In the display set 11 having 3×3 television receivers shown in FIG. 16, the leftmost (the first column from the left) 3×1 television receivers, the central (the second column from the left) 3×1 television receivers, and the rightmost (the third column from the left) 3×1 television receivers are grouped into units 11-1, 11-2, and 11-3, respectively. In this case, the units 11-1, 11-2, and 11-3 can be turned over to the back side by themselves.

The television receivers can receive remote controller commands sent from the remote controller 12 by the remote controller sensor 31. More specifically, in the unit 11-1, all the remote controller sensors 31₁₁, 31₁₂, and 31₁₃ of the three television receivers become effective so that they can receive remote controller commands from the remote controller 12. Similarly, in the unit 11-2, all the remote controller sensors 31₂₁, 31₂₂, and 31₂₃ of the three television receivers become effective so that they can receive remote controller commands from the remote controller 12, and in the unit 11-3, all the remote controller sensors 3131, 3132, and 3133 of the three television receivers become effective so that they can receive remote controller commands from the remote controller 12.

For example, in the display set 11, it is now assumed that the unit 11-2 is turned over to the back side when viewed from the viewer and that the viewer operates the remote controller 12 to transmit a remote controller command to the units 11-1 and 11-3 facing the front side. In this case, by using a signal medium which is necessary to be received from the front, such as infrared signals, the television receivers of the unit 11-2 facing the back side cannot receive the remote controller command and thus does not execute processing in accordance with the remote controller command.

In this case, only the television receivers of the units 11-1 and 11-3 facing the front receive the remote controller command and execute processing in accordance with the remote controller command.

In this manner, by transmitting remote controller commands via a signal medium which is necessary to be received from the front, such as infrared signals, and by allowing all the remote controller sensors 31 to be effective, instructions from the remote controller 12 can be received more simply.

As described above, according to an embodiment of the present invention, remote controller commands reflecting viewer's operations from the remote controller 12 can be reliably received, and also, the received remote controller commands can be executed.

In the television receivers facing in the same orientation, remote controller commands received by the remote controller sensor 31 of the main unit 21 are transferred to the sub-units 22. Accordingly, the reception status of the remote controller commands does not vary among the television receivers, and all the television receivers facing in the same orientation can reliably execute processing in accordance with the received remote controller commands.

Additionally, among television receivers combined as the display set 11, it can be determined which television receiver is used as the main unit (i.e., which remote controller sensor 31 is used) according to the installation position of each television receiver or the number of commands received by each television receiver. Thus, the possibility that the television receivers fail to receive remote controller commands becomes very low.

In the above-described example, when determining the main unit based on the position information, the television receiver 21₁₁ located at the bottom left (the first from the left and the third from the top) is used as the main unit 21. Alternatively, another television receiver, for example, the television receiver 21₃₁ located at the bottom right (the third from the left and the third from the top) may be used as the main unit 21.

Although in the above-described example only one television receiver serves as the main unit 21, a plurality of main units (for example, two main units) 21 may be used for receiving remote controller commands.

To determine the television receiver as the main unit 21 operating in the command distributor mode, two approaches, i.e., one approach to determining the main unit by the positions of the television receivers and the other approach to determining the main unit by the number of remote controller commands received by the television receivers, have been discussed. However, the main unit 21 may be determined manually by the operation of the viewer.

The above-described series of processing operations may be executed by hardware or software. If software is used, a corresponding software program is installed from a recording medium into a computer built in dedicated hardware or a computer, for example, a general-purpose computer, which can install various programs to execute various functions.

FIG. 17 is a block diagram illustrating an example of the configuration of a personal computer executing the above-described series of processing operations by the corresponding software program. A CPU 201 executes various processing in accordance with programs recorded on a ROM 202 or a storage unit 208. In a RAM 203, programs and data executed by the CPU 201 are stored. The CPU 201, the ROM 202, and the RAM 203 are connected to each other through a bus 204.

An input/output interface 205 is connected to the CPU 201 through the bus 204. An input unit 206, such as a keyboard, a mouse, and a microphone, and an output unit 207, such as a display and a speaker, are connected to the input/output interface 205. The CPU 201 executes various processing in response to instructions input from the input unit 206. The CPU 201 outputs processing results, such as images, to the output unit 207.

The storage unit 208 connected to the input/output interface 205 is formed of, for example, a hard disk, and stores programs and various data executed by the CPU 201. A communication unit 209 communicates with external devices via a network, such as the Internet. In this example, the communication unit 209 serves as an interface for receiving or outputting images from or to external devices.

Programs may be obtained through the communication unit 209 and are recorded in the storage unit 208.

A drive 210 connected to the input/output interface 205 drives a magnetic disk 221 (including a flexible disk), an optical disc 222 (including a compact disc read only memory (CD-ROM) or a digital versatile disc (DVD)), a magneto-optical disk 223 (including a mini disc (MD) (registered)), or a semiconductor memory 224 installed in the drive 210 to obtain programs and data stored in the corresponding medium. The obtained programs and data are transferred to and recorded in the storage unit 208 if necessary.

The recording medium storing the software program for executing the above-described series of processing operations may be formed of a package medium storing the program, such as the magnetic disk 221, the optical disc 222, the magneto-optical disk 223, or the semiconductor memory 224, which is distributed to viewers separately from the computer. Alternatively, the recording medium may be formed of the ROM 202 or a hard disk contained in the storage unit 208, which is provided to the viewers while being built in the computer.

Alternatively, the software program may be installed via a wired or wireless communication medium, such as a local area network (LAN), the Internet, or digital satellite broadcasting, through an interface, such as a router or a modem, if necessary.

In the specification, steps forming the programs stored in the recording medium may be executed in chronological order as disclosed in the specification. Alternatively, the steps may be executed in parallel or individually.

In the specification, the system represents the entire apparatus including a plurality of devices.

It should be understood by those skilled in the art that various modifications, combinations, sub-combinations and alterations may occur depending on design requirements and other factors insofar as they are within the scope of the appended claims or the equivalents thereof.

What is claimed is:

1. A display system comprising:
a first display device; and
a second display device,
the first display device including
first reception means for receiving a command sent from a remote controller in response to a viewer's operation,
first obtaining means for obtaining first information concerning an orientation of the first display device in the display system,
addition means for adding the obtained first information to the received command, and
transmission means for transmitting the command provided with the first information to the second display device,
the second display device including
second reception means for receiving the command provided with the first information transmitted from the first display device,
second obtaining means for obtaining second information concerning an orientation of the second display device in the display system,
determining means for determining whether the orientation of the second display device is the same as the orientation of the first display device by comparing the first information added to the command with the obtained second information, and
processing means for executing predetermined processing in accordance with the command when it is determined that the orientation of the second display device is the same as the orientation of the first display device.

2. A display device comprising:
first reception means for receiving a command sent from a remote controller in response to a viewer's operation;
first obtaining means for obtaining first information concerning an orientation of the display device;
addition means for adding the obtained first information to the received command; and
transmission means for transmitting the command provided with the first information to a different display device.

3. The display device according to claim 2, further comprising:
second obtaining means for obtaining second information concerning a position at which the display device is installed;
second reception means for receiving, from the different display device, third information concerning a position at which the different display device is installed and fourth information concerning an orientation of the different display device;
determining means for determining, based on the obtained first and second information and the received third and fourth information, whether the display device is installed at a predetermined position among display devices facing in the same orientation; and
mode control means for receiving, if it is determined that the display device is installed at the predetermined position, the command sent from the remote controller and shifting a mode of the display device to a first mode in which the received command is transmitted to the different display device, and if it is determined that the display device is not installed at the predetermined position, the mode control means shifting the mode of the display device to a second mode in which a command sent from the different display device is received without receiving the command sent from the remote controller.

4. The display device according to claim 2, further comprising:
storage means for storing second information concerning the number of commands received from the remote controller;
second reception means for receiving, from the different display device, third information concerning the number of commands received by the different display device and fourth information concerning an orientation of the different display device;
determining means for determining, based on the obtained first information, the stored second information, and the received third and fourth information, whether a reception status of the display device is the best among display devices facing in the same orientation; and
mode control means for receiving, if it is determined that the reception status of the display device is the best, the command sent from the remote controller and shifting a mode of the display device to a first mode in which the received command is transmitted to the different display device, and if it is determined that the reception status of the display device is not the best, the mode control means shifting the mode of the display device to a second mode in which a command sent from the different display device is received without receiving the command sent from the remote controller.

5. A display method comprising the steps of:
controlling the reception of a command sent from a remote controller in response to a viewer's operation;
obtaining first information concerning an orientation of a subject display device;
adding the obtained first information to the received command; and
controlling the transmission of the command provided with the first information to a different display device.

6. A program executed by a computer, comprising the steps of:
controlling the reception of a command sent from a remote controller in response to a viewer's operation;
obtaining first information concerning an orientation of a subject display device;
adding the obtained first information to the received command; and
controlling the transmission of the command provided with the first information to a different display device.

7. A recording medium recording thereon a program executed by a computer, the program comprising the steps of:
controlling the reception of a command sent from a remote controller in response to a viewer's operation;
obtaining first information concerning an orientation of a subject display device;
adding the obtained first information to the received command; and
controlling the transmission of the command provided with the first information to a different display device.

8. A display device comprising:
reception means for receiving, from a different display device, a command sent from a remote controller provided with first information concerning an orientation of the different display device;
first obtaining means for obtaining second information concerning an orientation of the display device;
determining means for determining whether the orientation of the display device is the same as the orientation of the different display device by comparing the first information added to the command with the obtained second information; and
processing means for executing predetermined processing in accordance with the command if it is determined that the orientation of the display device is the same as the orientation of the different display device.

9. The display device according to claim 8, wherein the reception means receives, from the different display device, the first information and third information concerning a position at which the different display device is installed.

10. The display device according to claim 9, further comprising:
second obtaining means for obtaining fourth information concerning a position at which the display device is installed;
determining means for determining, based on the received first and third information and the obtained second and fourth information, whether the display device is installed at a predetermined position among display devices facing in the same orientation; and
mode control means for receiving, if it is determined that the display device is installed at the predetermined position, the command sent from the remote controller and shifting a mode of the display device to a first mode in which the received command is transmitted to the different display device, and if it is determined that the display device is not installed at the predetermined position, the mode control means shifting the mode of the display device to a second mode in which the command sent from the different display device is received without receiving the command sent from the remote controller.

11. The display device according to claim 8, wherein the reception means receives, from the different display device, the first information and third information concerning the number of commands received by the different display device.

12. The display device according to claim 11, further comprising:
storage means for storing fourth information concerning the number of commands received from the remote controller;
determining means for determining, based on the received first and third information, the obtained second information, and the stored fourth information, whether a reception status of the display device is the best among display devices facing in the same orientation; and
mode control means for receiving, if it is determined that the reception status of the display device is the best, the command sent from the remote controller and shifting a mode of the display device to a first mode in which the received command is transmitted to the different display device, and if it is determined that the reception status of the display device is not the best, the mode control means shifting the mode of the display device to a second mode in which the command sent from the different display device is received without receiving the command sent from the remote controller.

13. A display method comprising the steps of:
controlling the reception of, from a different display device, a command sent from a remote controller provided with first information concerning an orientation of the different display device;
obtaining second information concerning an orientation of a subject display device;
determining whether the orientation of the subject display device is the same as the orientation of the different display device by comparing the first information added to the command with the obtained second information; and
executing predetermined processing in accordance with the command if it is determined that the orientation of the subject display device is the same as the orientation of the different display device.

14. A program executed by a computer, comprising the steps of:
controlling the reception of, from a different display device, a command sent from a remote controller provided with first information concerning an orientation of the different display device;
obtaining second information concerning an orientation of a subject display device;
determining whether the orientation of the subject display device is the same as the orientation of the different display device by comparing the first information added to the command with the obtained second information; and
executing predetermined processing in accordance with the command if it is determined that the orientation of the subject display device is the same as the orientation of the different display device.

15. A recording medium recording thereon a program executed by a computer, the program comprising the steps of:
controlling the reception of, from a different display device, a command sent from a remote controller provided with first information concerning an orientation of the different display device;
obtaining second information concerning an orientation of a subject display device;
determining whether the orientation of the subject display device is the same as the orientation of the different display device by comparing the first information added to the command with the obtained second information; and
executing predetermined processing in accordance with the command if it is determined that the orientation of the subject display device is the same as the orientation of the different display device.

16. A display system comprising:
a first display device; and
a second display device,
the first display device including
a first reception unit configured to receive a command sent from a remote controller in response to a viewer's operation,
a first obtaining unit configured to obtain first information concerning an orientation of the first display device in the display system,
an addition unit configured to add the obtained first information to the received command, and
a transmission unit configured to transmit the command provided with the first information to the second display device,
the second display device including
a second reception unit configured to receive the command provided with the first information transmitted from the first display device,
a second obtaining unit configured to obtain second information concerning an orientation of the second display device in the display system,
a determining unit configured to determine whether the orientation of the second display device is the same as the orientation of the first display device by comparing the first information added to the command with the obtained second information, and
a processing unit configured to execute predetermined processing in accordance with the command when it is determined that the orientation of the second display device is the same as the orientation of the first display device.

17. A display device comprising:
a first reception unit configured to receive a command sent from a remote controller in response to a viewer's operation;
a first obtaining unit configured to obtain first information concerning an orientation of the display device;
an addition unit configured to add the obtained first information to the received command; and
a transmission unit configured to transmit the command provided with the first information to a different display device.

18. A display device comprising:
a reception unit configured to receive, from a different display device, a command sent from a remote controller provided with first information concerning an orientation of the different display device;
a first obtaining unit configured to obtain second information concerning an orientation of the display device;
a determining unit configured to determine whether the orientation of the display device is the same as the orientation of the different display device by comparing the first information added to the command with the obtained second information; and
a processing unit configured to execute predetermined processing in accordance with the command if it is determined that the orientation of the display device is the same as the orientation of the different display device.
